(19) United States
(12) Patent Application Publication
(10) Pub. No.: US 2024/0291774 A1
(43) Pub. Date: Aug. 29, 2024

(54) RESOURCE UTILIZATION IN OVERLAY SYSTEMS USING PROJECTIONS

(71) Applicant: Infosys Limited, Bangalore (IN)

(72) Inventor: Steven Schilders, Columbus, IN (US)

(73) Assignees: Infosys Limited, Bangalore (IN); InvertlT Inc., Columbus, IN (US)

(21) Appl. No.: 18/589,322

(22) Filed: Feb. 27, 2024

Related U.S. Application Data
(60) Provisional application No. 63/448,738, filed on Feb. 28, 2023.
(60) Provisional application No. 63/448,724, filed on Feb. 28, 2023.
(60) Provisional application No. 63/448,831, filed on Feb. 28, 2023.
(60) Provisional application No. 63/448,711, filed on Feb. 28, 2023.
(60) Provisional application No. 63/449,231, filed on Mar. 1, 2023.

(51) Int. Cl. H04L 47/70

(52) U.S. Cl. CPC H04L 47/83; H04L 47/822

(57) ABSTRACT

An overlay system including a storage element and processing circuitry is provided. The storage element stores an executable graph-based model. The processing circuitry receives a contextualized stimulus. Further, the processing circuitry identifies nodes associated with processing of the contextualized stimulus and determines an association between each identified node and a node layer present in the executable graph-based model. The processing circuitry loads the identified nodes, simultaneously, into the executable graph-based model based on the determined association such that one or more identified nodes are loaded into at least one node layer. The identified nodes loaded into the executable graph-based model form a projection. The processing circuitry further executes an operation associated with the contextualized stimulus based on the projection.

### CROSS-REFERENCE TO RELATED APPLICATIONS/INCORPORATION BY REFERENCE

This patent application refers to, claims priority to, and claims the benefit of U.S. Provisional Application Ser. No. 63/448,738, filed Feb. 28, 2023; 63/448,724, filed Feb. 28, 2023; 63/448,831, filed Feb. 28, 2023; 63/448,711, filed Feb. 28, 2023; and 63/449,231, filed Mar. 1, 2023. Each of the above-referenced applications is hereby incorporated herein by reference in its entirety.

### FIELD OF THE DISCLOSURE

Various embodiments of the present disclosure relate generally to graph-based models. More specifically, various embodiments of the present disclosure relate to resource utilization in overlay systems using projections.

### BACKGROUND

Information technology has carved its space in various domains such as healthcare, finance, robotics, business, or the like. Both artificial intelligence and machine learning are integral components of information technology and improve the efficiency of operations associated therewith by digitizing and automating them. To keep up with the demands of domains that also implement various advanced and cutting-edge technologies, digitization and automation of the operations are required to perform at par with them. Digitization and automation of the operations require the usage of a software-based application. Further, data and processing logic are required for the execution of such a software-based application. Thus, there is a requirement for a solution to store the associated data and processing logic. Traditionally, data and processing logic associated with software-based applications are stored in a storage element associated with a digitization and automation system. The data and processing logic associated with a software-based application are vast, and hence, efficient resource utilization in such a storage element is crucial.

In light of the foregoing, there exists a need for a technical and reliable solution that overcomes the abovementioned problems.

Limitations and disadvantages of conventional and traditional approaches will become apparent to one of skill in the art, through the comparison of described systems with some aspects of the present disclosure, as set forth in the remainder of the present disclosure and with reference to the drawings.

### SUMMARY

Methods and systems for resource utilization in overlay systems using projections are provided substantially as shown in, and described in connection with, at least one of the figures.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

Embodiments of the present disclosure are illustrated by way of example and are not limited by the accompanying figures. Similar references in the figures may indicate similar elements. Elements in the figures are illustrated for simplicity and clarity and have not necessarily been drawn to scale.

FIG. 1 is a graph that illustrates a composition of an executable graph-based model, in accordance with an embodiment of the present disclosure;

FIG. 2 is a block diagram that illustrates a system environment of an overlay system for execution, management, and configuration of the executable graph-based model of FIG. 1, in accordance with an embodiment of the present disclosure;

FIG. 3A is a block diagram that illustrates a generic structure of a node within the executable graph-based model of FIG. 1, in accordance with an embodiment of the present disclosure;

FIG. 3B is a block diagram that illustrates a generic structure of a run-time node within the executable graph-based model of FIG. 1, in accordance with an embodiment of the present disclosure;

FIG. 4 is a block diagram that illustrates an executable node within the executable graph-based model, in accordance with an embodiment of the present disclosure;

FIG. 5 is a block diagram that illustrates a composition of the executable node that enables persistent storage of data and the processing logic associated therewith, in accordance with an embodiment of the present disclosure;

FIG. 6A is a schematic diagram that illustrates resource utilization in the overlay system using projections, in accordance with an embodiment of the present disclosure;

FIG. 6B is a schematic diagram that illustrates resource utilization in the overlay system using projections, in accordance with another embodiment of the present disclosure;

FIG. 6C is a schematic diagram that illustrates resource utilization in the overlay system using projections, in accordance with another embodiment of the present disclosure;

FIG. 6D is a schematic diagram that illustrates resource utilization in the overlay system using projections, in accordance with another embodiment of the present disclosure;

FIG. 6E is a schematic diagram that illustrates resource utilization in the overlay system using projections, in accordance with another embodiment of the present disclosure;

FIG. 6F is a schematic diagram that illustrates resource utilization in the overlay system using projections, in accordance with another embodiment of the present disclosure;

FIG. 6G is a schematic diagram that illustrates resource utilization in the overlay system using projections, in accordance with another embodiment of the present disclosure;

FIGS. 7A and 7B are schematic diagrams that collectively illustrate resource utilization in the overlay system using projections, in accordance with yet another embodiment of the present disclosure;

FIGS. 8A and 8B are schematic diagrams that collectively illustrate an example implementation of resource utilization in the overlay system using projections, in accordance with an embodiment of the present disclosure;

FIG. 9 shows an example computing system for carrying out the methods of the present disclosure, in accordance with an embodiment of the present disclosure; and

FIGS. 10A-10C, collectively, represents a flowchart that illustrates a method for facilitating resource utilization using projections in the overlay system, in accordance with an embodiment of the present disclosure.

### DETAILED DESCRIPTION

The detailed description of the appended drawings is intended as a description of the embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

### Overview

Conventionally, data and processing logic associated with a software-based application are loaded into a storage element (such as Random Access Memory) from a large storage device and stored in the storage element for executing the software application for the digitization and automation of a task. In such a scenario, entire data and processing logic remains loaded in the storage element while the software application gets executed. While the digitization and automation of a task may include various operations, the entire data and processing logic is not required for each operation. Thus, the resource of the storage element is not utilized efficiently. In another scenario, the data and processing logic associated with a software-based application is loaded into the storage element upon demand. That is to say, the data and processing logic associated with a software-based application is loaded into the storage element just before executing the software application. In such a scenario, retrieval of the data and processing logic from the large storage device and loading of the same into the storage element is time-consuming, and thus, causes significant delay in executing a corresponding operation. The significant delay may lead to undesirable outcomes during real-time operations.

The present disclosure is directed to resource utilization in overlay systems using projections. The overlay system includes a primary storage element and a secondary storage element. The secondary storage element stores various roles, edges, and vertices that are realized by way of nodes. Each node is associated with a particular node type. For example, an edge node corresponds to a node with an edge node type. Nodes (for example, vertices) are connected with other nodes by way of edge nodes (e.g., roles included in the edge nodes). In some embodiments, roles are represented by way of nodes of role node type. A role node between two nodes may be indicative of a context of an association therebetween. The secondary storage element may further comprise overlay nodes to extend the functionality of the nodes such as vertices and edges with processing logic. The secondary storage element stores all nodes and associated processing logic that are linked to the overlay system.

The primary storage element comprises executable graph-based models. Executable graph-based models are customized hypergraphs. Execution of any operation associated with the overlay system is based on the executable graph-based models stored in the primary storage element. The primary storage element has a lower storage capacity in comparison to the secondary storage element. Thus, a projection that includes all necessary nodes for the execution of a particular operation is loaded into the primary storage element from the secondary storage element whenever required. The projection refers to a package of nodes that include data and processing logic for executing an operation. As a result, resource utilization of the primary storage element is efficient.

In an example, the primary storage element of the overlay system includes an executable graph-based model. The executable graph-based model includes various node layers. Each node layer may be associated with a node layer identifier. Additionally, each node layer is configured to accommodate one or more nodes. Further, the secondary storage element includes multiple nodes associated with the overlay system. In operation, processing circuitry of the overlay system may receive a stimulus. The processing circuitry may identify, from the nodes stored in the secondary storage element, one or more nodes for stimulus processing. Further, the processing circuitry may determine, for each node, an association with a node layer of the executable graph-based model. The identified one or more nodes are loaded into the executable graph-based model based on the determined association such that each identified node is loaded into the associated node layer. Also, the identified nodes are loaded simultaneously. The identified nodes loaded into the executable graph-based model constitute a projection. Upon the loading of the projection, an operation associated with the stimulus is executed based on the nodes of the projection. Additionally, one or more nodes of the projection, one or more node layers of the projection, or the entire projection may be unloaded from the executable graph-based model based on the execution of the operation associated with the stimulus or based on resource constraint in the primary storage element.

Traditional approaches to resource utilization of the storage element involve storing all the data and processing logic associated with the system into the primary storage element for the execution of an operation. Thus, the resource of the storage element is not utilized efficiently. In contrast, the present disclosure provides resource utilization in the overlay system using projections, where a projection that includes only the required data and processing logic is loaded into the primary storage element for the execution of the operation. In another traditional approach, all the data and processing logic associated with the system is loaded into the primary storage element upon demand. As a result, significant delay is induced in the execution of the operation as loading of all the data and processing logic is time-consuming. In contrast, the projection that includes only the required data and processing logic is loaded into the primary storage element for execution of the operation on demand. Thus, the delay induced in the execution of the operation is significantly reduced. Additionally, one or more nodes of the projection, one or more node layers of the projection, or the entire projection may be unloaded from the primary storage element upon completion of the utilization associated therewith or upon determining that the resource of the primary storage element is exhausted. Thus, resource utilization is efficient in the overlay system of the present disclosure.

Systems and methods for facilitating resource utilization in overlay systems using projections are provided. As projection including only the necessary nodes is loaded into the primary storage element, the resource utilization of the primary storage element is efficient. The efficiency of the resource utilization may be further improved by unloading one or more nodes, one or more node layers, or an entire projection from the primary storage element whenever a resource shortage arises in the primary storage element. Additionally, multiple nodes of the projection are loaded simultaneously, from the secondary storage element to the primary storage element, thereby resulting in reduced time consumption in loading the projection and stimulus processing. Further, the time complexity associated with stimulus processing is also reduced. The reduction in time complexity is beneficial in applications such as healthcare, finance, robotics, and the like, that involve time-critical operations based on resource utilization. Thus, the systems and methods disclosed herein provide an efficient approach to resource utilization in overlay systems in a seamless manner.

### Figure Description

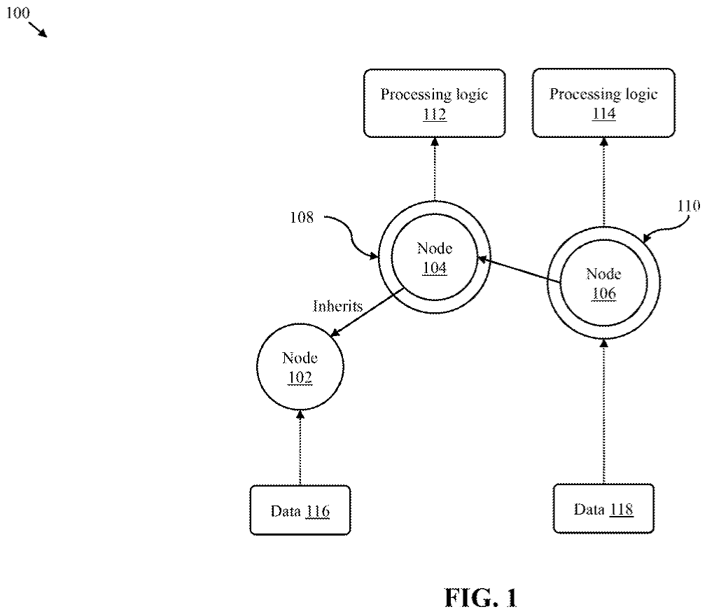

FIG. 1 is a graph that illustrates a composition of an executable graph-based model 100, in accordance with an embodiment of the present disclosure. Referring to FIG. 1, the executable graph-based model 100 is generally formed of a data structure (e.g., a graph-based model or a graphical model) comprising a plurality of nodes 102-106 which can be functionally extended with processing logic via the use of overlays. For example, as shown in FIG. 1, the nodes 104 and 106 are functionally extended with processing logic via the use of overlays 108 and 110, respectively. Although not shown, it will be apparent to a person skilled in the art that the node 102 can be similarly extended with processing logic via the use of one or more overlays. Each overlay includes processing logic, such as processing logic 112 and 114 which are associated with the overlays 108 and 110, respectively. At run-time, data, such as data 116 and 118, is associated with the nodes 102 and 106, respectively, of the executable graph-based model 100. Further, the overlays 108 and 110 of the nodes 104 and 106, respectively, provide the functionality to respond to stimuli and interact with, manipulate, or otherwise process the data for managing resource utilization in the executable graph-based model 100. Further, the node 104 inherits the node 102, and hence, also inherits the data 116 which is associated with the node 102. In some embodiments, the node 102 may be extended to have one or more overlays. In such embodiments, the node 104 may further inherit the overlays of the node 102.

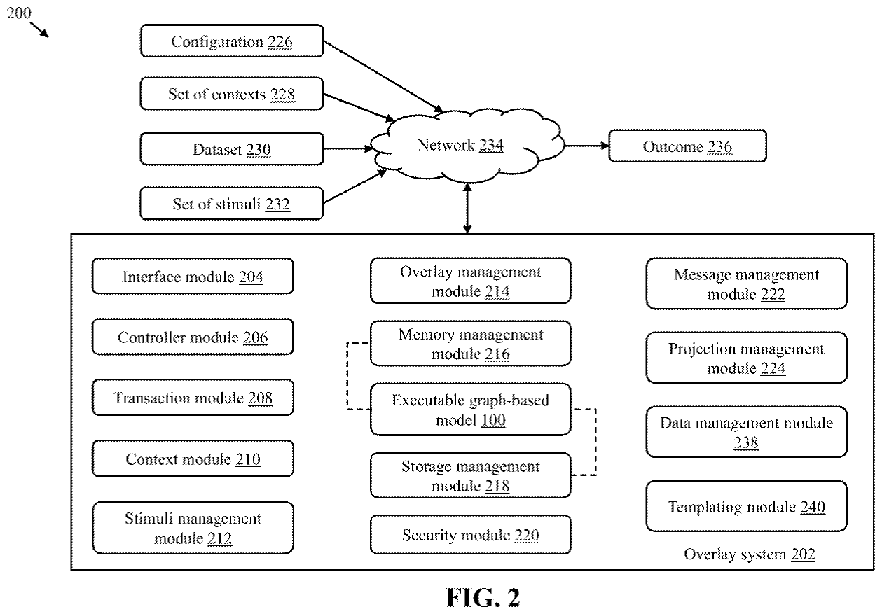

Each element within the executable graph-based model 100 (both the data and the processing functionality) is a node. A node forms the fundamental building block of all executable graph-based models. A node may be an executable node. A node extended by way of an overlay node forms an executable node. One or more nodes are extended to include overlays in order to form the executable graph-based models. As such, the executable graph-based model 100 includes one or more nodes that can be dynamically generated, extended, or processed by one or more other modules within an overlay system (shown in FIG. 2).

As such, the structure and functionality of the data processing are separate from the data itself when offline (or at rest) and are combined dynamically at run-time. The executable graph-based model 100 thus maintains the separability of the data and the processing logic when offline. Moreover, by integrating the data and the processing logic within a single model, processing delays or latencies are reduced because the data and the processing logic exist within the same logical system. Therefore, the executable graph-based model 100 is applicable to a range of time-critical systems where efficient processing of the stimuli is required. In an instance, the executable graph-based model 100 may be used for in-situ processing of stimuli such as a command, a query, or the like.

FIG. 2 is a block diagram that illustrates a system environment 200 of an overlay system 202 for execution, management, and configuration of the executable graph-based model 100, in accordance with an embodiment of the present disclosure. Referring to FIG. 2, the overlay system 202 includes the executable graph-based model 100. The overlay system 202 further includes an interface module 204, a controller module 206, a transaction module 208, a context module 210, a stimuli management module 212, an overlay management module 214, a memory management module 216, a storage management module 218, a security module 220, a message management module 222, and a projection management module 224. FIG. 2 further shows a configuration 226, a set of contexts 228, a dataset 230, a set of stimuli 232, a network 234, and an outcome 236.

The overlay system 202 may include suitable logic, circuitry, interfaces, and/or code, executable by the circuitry, that may be configured to facilitate resource utilization in executable graph-based models (such as the executable graph-based model 100). The executable graph-based model 100 corresponds to an application-specific combination of data and processing functionality which is manipulated, processed, and/or otherwise handled by other modules within the overlay system 202 for creation, maintenance, and utilization (e.g., processing) of projections therein based on the set of stimuli 232 received by the overlay system 202. Each stimulus in the set of stimuli 232 corresponds to a command, a query, or an event.

The interface module 204 may include suitable logic, circuitry, interfaces, and/or code, executable by the circuitry, configured to provide a common interface between internal modules of the overlay system 202 and/or external sources. The interface module 204 provides an application programmable interface (API), scripting interface, or any other suitable mechanism for interfacing externally or internally with any module of the overlay system 202. As shown in FIG. 1, the configuration 226, the set of contexts 228, the dataset 230, and the set of stimuli 232 are received by the interface module 204 via the network 234. Similarly, outputs produced by the overlay system 202, such as the outcome 236, are passed by the interface module 204 to the network 234 for consumption or processing by external systems. In one embodiment, the interface module 204 supports one or more messaging patterns or protocols such as the simple object access protocol (SOAP), the representational state transfer (REST) protocol, or the like. The interface module 204 thus allows the overlay system 202 to be deployed in any number of application areas, operational environments, or architecture deployments. Although not illustrated in FIG. 1, the interface module 204 is communicatively coupled (e.g., connected either directly or indirectly) to one or more other modules or elements within the overlay system 202 (such as the controller module 206, the context module 210, the executable graph-based model 100, or the like). In one embodiment, the interface module 204 is communicatively coupled (e.g., connected either directly or indirectly) to one or more overlays within the executable graph-based model 100.

The controller module 206 may include suitable logic, circuitry, interfaces, and/or code, executable by the circuitry, configured to handle and process interactions and executions within the overlay system 202. As will be described in more detail below, stimuli (such as the set of stimuli 232) and their associated contexts provide the basis for all interactions within the executable graph-based model 100. Processing of such stimuli may lead to the execution of processing logic associated with one or more overlays within the executable graph-based model 100. The processing of the stimuli within the overlay system 202 may be referred to as a system transaction. The processing and execution of stimuli (and associated overlay execution) within the overlay system 202 is handled by the controller module 206. The controller module 206 manages all received input stimuli and processes them based on a corresponding context. Each context determines the priority that is assigned to process the corresponding stimulus by the controller module 206 or the context module 210. This allows each stimulus to be configured with a level of importance and prioritization within the overlay system 202.

The controller module 206 may maintain the integrity of the modules within the overlay system 202 before, during, and after a system transaction. The transaction module 208, which is associated with the controller module 206, is responsible for maintaining the integrity of the overlay system 202 through the lifecycle of a transaction. Maintaining system integrity via the controller module 206 and the transaction module 208 allows a transaction to be rolled back in the event of an expected or unexpected software or hardware fault or failure. The controller module 206 is configured to handle the processing of the set of stimuli 232 and transactions through architectures such as parallel processing, grid computing, priority queue techniques, or the like. In one embodiment, the controller module 206 and the transaction module 208 are communicatively coupled (e.g., connected either directly or indirectly) to one or more overlays within the executable graph-based model 100.

As stated briefly above, the overlay system 202 utilizes a context-driven architecture whereby the set of stimuli 232 within the overlay system 202 is associated with the set of contexts 228 which is used to adapt the handling or processing of the set of stimuli 232 by the overlay system 202. The handling or processing of the set of stimuli 232 is done based on the set of contexts 228 associated therewith. Hence, each stimulus of the set of stimuli 232 is considered to be a contextualized stimulus. Each context of the set of contexts 228 may include details such as username, password, access token, device information, time stamp, one or more relevant identifiers (IDs), or the like, that are required for processing of a corresponding stimulus of the set of stimuli 232 within the executable graph-based model 100. Each context within the overlay system 202 may be extended to include additional information that is required for the processing of the corresponding stimulus (e.g., a query or a command).

The context module 210 may include suitable logic, circuitry, interfaces, and/or code, executable by the circuitry, configured to manage the handling of contexts within the overlay system 202, and is responsible for processing any received contexts (e.g., the set of contexts 228) and translating the received context to an operation execution context. In some examples, the operation execution context is larger than the received context because the context module 210 supplements the received context with further information necessary for the processing of the received context. The context module 210 passes the operational execution context to one or more other modules within the overlay system 202 to facilitate the creation, maintenance, and utilization of projections in the executable graph-based model 100. Contexts within the overlay system 202 can be external or internal. While some contexts apply to all application areas and problem spaces, some applications may require specific contexts to be generated and used to process the received set of stimuli 232. As will be described in more detail below, the executable graph-based model 100 is configurable (e.g., via the configuration 226) so as only to execute within a given execution context for a given stimulus.

The stimuli management module 212 may include suitable logic, circuitry, interfaces, and/or code, executable by the circuitry, configured to process externally received stimuli (e.g., the set of stimuli 232) and any stimuli generated internally from any module within the overlay system 202. The stimuli management module 212 is communicatively coupled (e.g., connected either directly or indirectly) to one or more overlays within the executable graph-based model 100 to facilitate the processing of stimuli within the executable graph-based model 100. The overlay system 202 utilizes different types of stimuli such as a command (e.g., a transactional request), a query, or an event received from an external system such as an Internet-of-Things (IoT) device. As previously stated, each stimulus of the set of stimuli 232 can be either externally or internally generated. In an example, each stimulus of the set of stimuli 232 may be a message that is internally triggered (generated) from any of the modules within the overlay system 202. Such internal generation of the set of stimuli 232 indicates that something has happened within the overlay system 202 such that subsequent handling by one or more other modules within the overlay system 202 may be required. An internal set of stimuli 232 can also be triggered (generated) from the execution of processing logic associated with overlays within the executable graph-based model 100. In another example, the set of stimuli 232 may be externally triggered and may be generated based on an input received via a user interface associated with the controller module 206. The externally triggered set of stimuli 232 may be received in the form of a textual, audio, or visual input. The externally triggered set of stimuli 232 may be associated with the intent of a user to execute a set of operations indicated by the set of stimuli 232. The operation is executed in accordance with the information included in the set of contexts 228 associated with the set of stimuli 232.

The stimuli management module 212 may receive the stimuli in real-time or near-real-time and communicate the received set of stimuli 232 to one or more other modules or nodes of the executable graph-based model 100. In some examples, the stimuli are scheduled in a batch process. The stimuli management module 212 utilizes any suitable synchronous or asynchronous communication architectures or approaches in communicating the stimuli (along with associated information). The stimuli within the overlay system 202 are received and processed (along with a corresponding context) by the stimuli management module 212, which then determines the processing steps to be performed for the execution of an operation associated with each stimulus of the set of stimuli 232. In one embodiment, the stimuli management module 212 processes the received stimuli in accordance with a predetermined configuration (e.g., the configuration 226) or dynamically determines what processing needs to be performed based on the contexts associated with the stimuli and/or based on a state of the executable graph-based model 100. The state of the executable graph-based model 100 refers to the current state of each node of the executable graph-based model 100 at a given point in time. The state of the executable graph-based model 100 is dynamic, and hence, may change in response to the execution of an operation based on any of its nodes. In some examples, the processing of each stimulus of the set of stimuli 232 results in the creation, maintenance, or utilization of projections that further result in one or more outcomes being generated (e.g., the outcome 236). Such outcomes are either handled internally by one or more modules in the overlay system 202 or communicated via the interface module 204 as an external outcome. In one embodiment, all stimuli and corresponding outcomes are recorded for auditing and post-processing purposes by, for example, an operations module (not shown) and/or an analytics module (not shown) of the overlay system 202.

The overlay management module 214 may include suitable logic, circuitry, interfaces, and/or code, executable by the circuitry, configured to manage all overlays within the overlay system 202. Operations performed by the overlay management module 214 include overlay storage management, overlay structure modeling, overlay logic creation and execution, and overlay loading and unloading (within the executable graph-based model 100). The overlay management module 214 is communicatively coupled (e.g., connected either directly or indirectly) to one or more other modules within the overlay system 202 to complete some or all of these operations. For example, overlays can be persisted in some form of physical storage using the storage management module 218 (as described in more detail below). As a further example, overlays can be compiled and preloaded into memory via the memory management module 216 for faster run-time execution.

The memory management module 216 may include suitable logic, circuitry, interfaces, and/or code, executable by the circuitry, configured to manage and optimize the memory usage of the overlay system 202. The memory management module 216 thus helps to improve the responsiveness and efficiency of the processing performed by one or more of the modules within the overlay system 202 by optimizing the memory handling performed by these modules. The memory management module 216 uses direct memory or some form of distributed memory management architecture (e.g., a local or remote caching solution). Additionally, or alternatively, the memory management module 216 deploys multiple different types of memory management architectures and solutions (e.g., reactive caching approaches such as lazy loading or a proactive approach such as write-through cache may be employed). These architectures and solutions are deployed in the form of a flat (single-tiered) cache or a multi-tiered caching architecture where each layer of the caching architecture can be implemented using a different caching technology or architecture solution approach. In such implementations, each cache or caching tier can be configured (e.g., by the configuration 226) independently of the requirements for one or more modules of the overlay system 202. For example, data priority and eviction strategy, such as least-frequently-used (LFU) or least-recently-used (LRU), can be configured for all or parts of the executable graph-based model 100. In one embodiment, the memory management module 216 is communicatively coupled (e.g., connected either directly or indirectly) to one or more overlays within the executable graph-based model 100. The memory management module 216 may be further configured to facilitate storage and processing of the executable graph-based model 100 in a primary storage element associated therewith.

The storage management module 218 may include suitable logic, circuitry, interfaces, and/or code, executable by the circuitry, configured to manage the temporary or permanent storage of data to improve resource utilization in the overlay system 202. The storage management module 218 is any suitable low-level storage device solution (such as a file system) or any suitable high-level storage technology such as another database technology (e.g., relational database management system (RDBMS) or NoSQL database). The storage management module 218 is directly connected to the storage device upon which the relevant data is persistently stored. For example, the storage management module 218 can directly address the computer-readable medium (e.g., hard disk drive, external disk drive, or the like) upon which the data is being read or written. Alternatively, the storage management module 218 is connected to the storage device via a network, such as the network 234. As will be described in more detail later in the present disclosure, the storage management module 218 uses ‘manifests’ to manage the interactions between the storage device and the modules within the overlay system 202. In one embodiment, the storage management module 218 is communicatively coupled (e.g., connected either directly or indirectly) to one or more overlays within the executable graph-based model 100. The storage management module 218 may be further configured to facilitate the storage of multiple nodes associated with the overlay system 202 in a secondary storage element associated therewith.

The security module 220 may include suitable logic, circuitry, interfaces, and/or code, executable by the circuitry, configured to manage the security of the overlay system 202. This includes security at a system level and a module level. Security is hardware-related, network-related, or software-related, depending on the operational environment, the architecture of the deployment, or the data and information contained within the overlay system 202. For example, if the system is deployed with a web-accessible API (as described above in relation to the interface module 204), the security module 220 can enforce a hypertext transfer protocol secure (HTTPS) protocol with the necessary certification. As a further example, if the data or information associated with the message received or processed by the overlay system 202 contains Personally Identifiable Information (PII) or Protected Health Information (PHI), the security module 220 can implement one or more layers of data protection to ensure that the PII or PHI is correctly processed and stored. In an additional example, in implementations where the overlay system 202 operates on United States of America citizen medical data, the security module 220 may enforce additional protections or policies as defined by the United States Health Insurance Portability and Accountability Act (HIPAA). Similarly, if the overlay system 202 is deployed in the European Union (EU), the security module 220 may enforce additional protections or policies to ensure that the data processed and maintained by the overlay system 202 complies with the General Data Protection Regulation (GDPR). In one embodiment, the security module 220 is communicatively coupled (e.g., connected either directly or indirectly) to one or more overlays within the executable graph-based model 100 thereby directly connecting security execution to the data/information in the executable graph-based model 100.

The message management module 222 may include suitable logic, circuitry, interfaces, and/or code, executable by the circuitry, configured to manage all data or information associated with messages communicated within the overlay system 202 (e.g., the dataset 230) for a given communication network implemented by way of the executable graph-based model 100. Operations performed by the message management module 222 include data loading, data unloading, data modeling, and data processing operations associated with the generation and communication of messages within the overlay system 202. The message management module 222 is communicatively coupled (e.g., connected either directly or indirectly) to one or more other modules within the overlay system 202 to complete some or all of these operations. For example, the storage of data or information associated with messages is handled in conjunction with the storage management module 218.

The projection management module 224 may include suitable logic, circuitry, interfaces, and/or code, executable by the circuitry, configured to manage all data and information associated with the creation, utilization, modification, and deletion of projections within the overlay system 202. A projection includes a plurality of nodes associated with stimulus processing. Operations performed by the projection management module 224 may include the generation, utilization, and deletion of projections. In an example, the projection includes the plurality of nodes 102-106 and the overlays 108 and 110. The projection is created based on one or more stimuli (such as the set of stimuli 232). The projection management module 224 may be further configured to create node layers in the executable graph-based model 100. The node layers in the executable graph-based model 100 accommodate the plurality of nodes of the projection. The projection management module 224 is communicatively coupled (e.g., connected either directly or indirectly) to one or more other modules within the overlay system 202 to complete some or all of these operations. The projection management module 224 is further communicatively coupled (i.e., connected either directly or indirectly) to one or more nodes and/or one or more overlays within the executable graph-based model 100.

In addition to the abovementioned components, the overlay system 202 further includes a data management module 238. The data management module 238 may include suitable logic, circuitry, interfaces, and/or code, executable by the circuitry, configured to manage all data or information (e.g., the dataset 230) within the overlay system 202 for a given application. Operations performed by the data management module 238 include data loading, data unloading, data modeling, and data processing. The data management module 238 is communicatively coupled (e.g., connected either directly or indirectly) to one or more other modules within the overlay system 202 to complete some or all of these operations. For example, data storage is handled by the data management module 238 in conjunction with the storage management module 218.

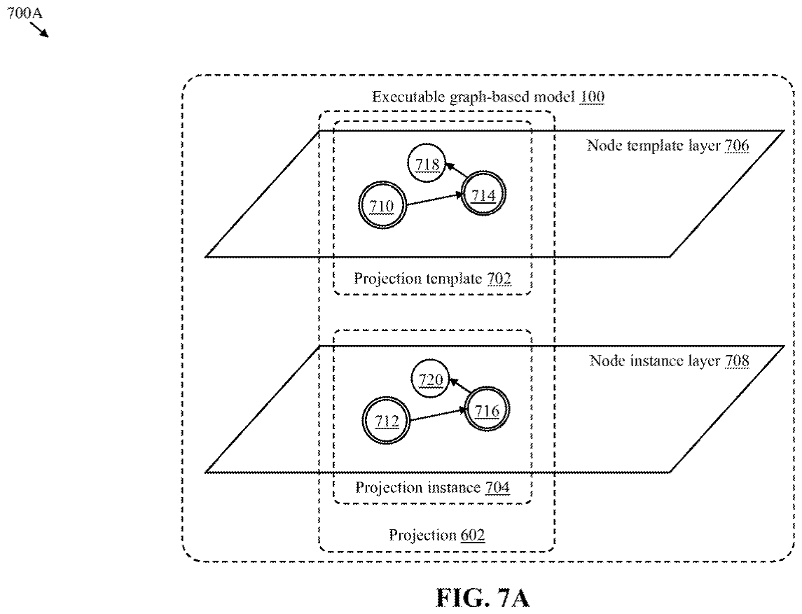

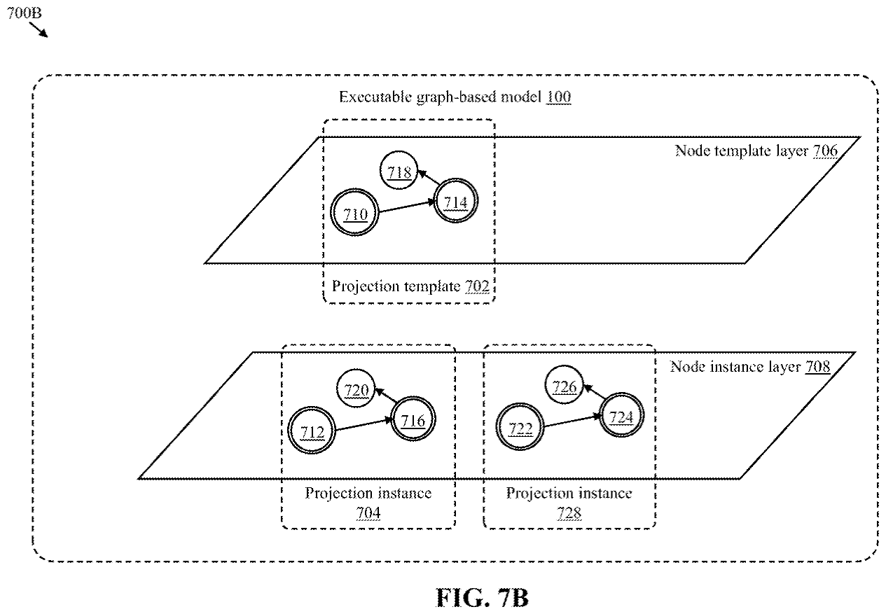

In one embodiment of the present disclosure, the overlay system 202 may further include a templating module 240. The templating module 240 may include suitable logic, circuitry, interfaces, and/or code, executable by the circuitry, configured to implement a templated version of the executable graph-based model 100. The templating module 240 may be further configured to generate specific instances of nodes from predefined templates for the implementation of the templated version of the executable graph-based model 100. In the templated version of the executable graph-based model 100, each node includes a node template and one or more node instances. The node template corresponds to a predefined node structure and each node instance corresponds to an implementation of the corresponding node template The templating module 240 ensures ontology integrity by enforcing the structure and rules of a template when generating instances of the template at run-time. The templating module 240 is communicatively coupled (i.e., connected either directly or indirectly) to one or more nodes and/or one or more overlays within the templated version of the executable graph-based model 100. Resource utilization in the overlay system 202 using the templated version of the executable graph-based model 100 is further described in detail in conjunction with FIGS. 7A and 7B.

In some embodiments, all the modules of the overlay system 202, except for the executable graph-based model 100, may collectively form processing circuitry that executes operations associated with the resource utilization within the overlay system 202.

The functionality of two or more of the modules included in the overlay system 202 may be combined within a single module. Conversely, the functionality of a single module can be split into two or more further modules which can be executed on two or more devices. The modules described above in relation to the overlay system 202 can operate in a parallel, distributed, or networked fashion. The overlay system 202 may be implemented in software, hardware, or a combination of both software and hardware. Examples of suitable hardware modules include a general-purpose processor, a field programmable gate array (FPGA), and/or an application-specific integrated circuit (ASIC). Software modules can be expressed in a variety of software languages such as C, C++, Java, Ruby, Visual Basic, Python, and/or other object-oriented, procedural, or programming languages.

It will be apparent to a person skilled in the art that whilst only one executable graph-based model 100 is shown in FIG. 2, in other embodiments the overlay system 202 stores and maintains more than one executable graph-based model, without deviating from the scope of the present disclosure. In such embodiments, resource utilization associated with each executable graph-based model is in a manner that is similar to that in the executable graph-based model 100.

Having described the overlay system 202 for executing and managing executable graph-based models, the description will now turn to the elements of an executable graph-based model; specifically, the concept of a node. Unlike conventional graph-based systems, all elements (e.g., data, overlays, etc.) within the executable graph-based model (e.g., the executable graph-based model 100) are implemented as nodes. As will become clear, this allows executable graph-based models to be flexible, extensible, and highly configurable.

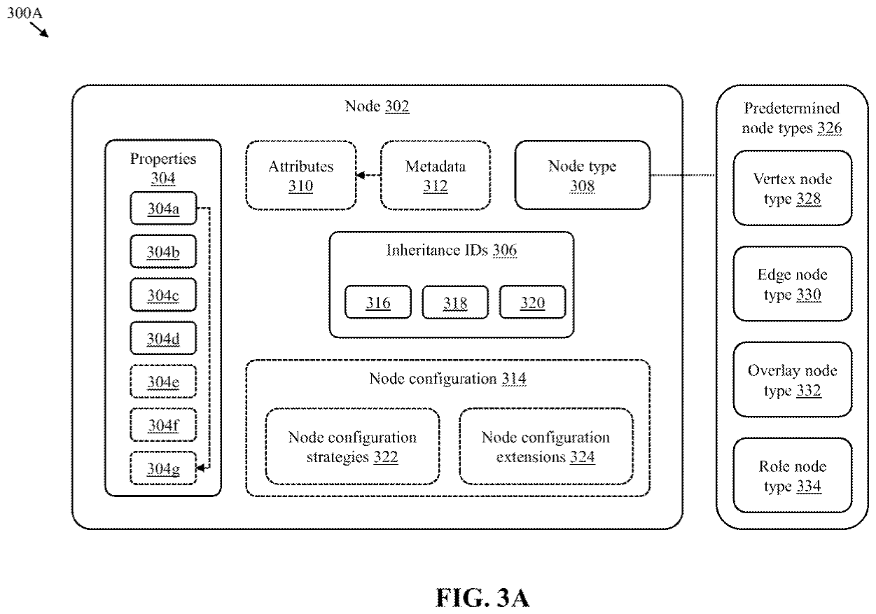

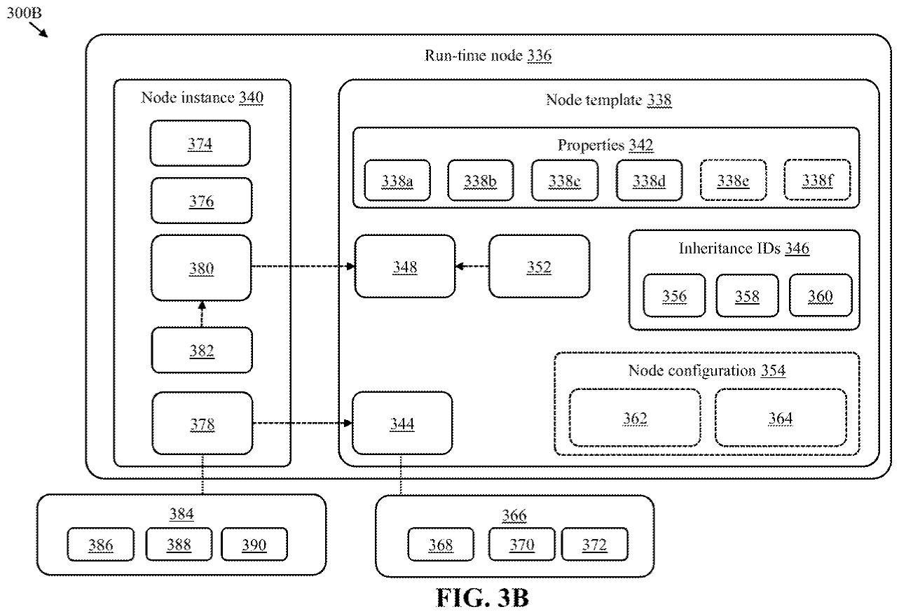

FIG. 3A is a block diagram 300A that illustrates a generic structure of a node 302 within the executable graph-based model 100, in accordance with an embodiment of the present disclosure. Referring to FIG. 3A, the node 302 corresponds to the core structure of the executable graph-based model 100 and forms the foundational building block for all data and processing logic within the executable graph-based model 100. The node 302 includes properties 304, inheritance IDs 306, and a node type 308. The node 302 optionally includes one or more attributes 310, metadata 312 associated with the attributes 310, and a node configuration 314.

The properties 304 of the node 302 include a unique ID 304a, a version ID 304b, a namespace 304c, and a name 304d. The properties 304 optionally include one or more icons 304e, one or more labels 304f, and one or more alternative IDs 304g. The inheritance IDs 306 of the node 302 include an abstract flag 316, a leaf flag 318, and a root flag 320. The node configuration 314 optionally includes one or more node configuration strategies 322 and one or more node configuration extensions 324.

The unique ID 304a is unique for each node within the executable graph-based model 100. The unique ID 304a is used to register, manage, and reference the node 302 within the system (e.g., the overlay system 202). In some embodiments, the one or more alternative IDs 304g are associated with the unique ID 304a to help manage communications and connections with external systems (e.g., during configuration, sending stimuli, or receiving outcomes). The version ID 304b of the node 302 is incremented when the node 302 undergoes transactional change. This allows the historical changes between versions of the node 302 to be tracked by modules or overlays within the overlay system 202. The namespace 304c of the node 302, along with the name 304d of the node 302, is used to help organize nodes within the executable graph-based model 100. That is, the node 302 is assigned a unique name 304d within the namespace 304c such that the name 304d of the node 302 need not be unique within the entire executable graph-based model 100, only within the context of the namespace 304c to which the node 302 is assigned. The node 302 optionally includes one or more icons 304e which are used to provide a visual representation of the node 302 when visualized via a user interface. The one or more icons 304e can include icons at different resolutions and display contexts such that the visualization of the node 302 is adapted to different display settings and contexts. The node 302 also optionally includes one or more labels 304f which are used to override the name 304d when the node 302 is rendered or visualized.

The node 302 supports the concept of inheritance of data and processing logic associated with any other node of the executable graph-based model 100 that is inherited by the node 302. This allows the behavior and functionality of the node 302 to be extended or derived from the inherited node of the executable graph-based model 100. The inheritance IDs 306 of the node 302 indicate the inheritance-based information, which may be applicable to the node 302. The inheritance IDs 306 comprise a set of Boolean flags which identify the inheritance structure of the node 302. The abstract flag 316 allows the node 302 to support the construct of abstraction. When the abstract flag 316 takes a value ‘true’, the node 302 is flagged as abstract that is to say that it cannot be instantiated or created within an executable graph-based model (e.g., the executable graph-based model 100). Thus, in an instance when the node 302 has the abstract flag 316 set to ‘true’, the node 302 may only form the foundation of other nodes that inherit therefrom. By default, the abstract flag 316 of the node 302 is set to ‘false’. The leaf flag 318 is used to indicate whether any other node may inherit from the node 302. If the leaf flag 318 is set to ‘true’, then no other node may inherit from the node 302 (but unlike an abstract node, a node with the leaf flag 318 set may be instantiated and created within the executable graph-based model 100). The root flag 320 is used to indicate whether the node 302 inherits from any other node. If the root flag 320 is set to ‘true’, the node 302 does not inherit from any other node. The node 302 is flagged as leaf (e.g., the leaf flag 318 is set to ‘true’) and/or root (e.g., the root flag 320 is set to ‘true’), or neither (e.g., both the leaf flag 318 and the root flag 320 are set to ‘false’). It will be apparent to a person skilled in the art that a node cannot be flagged as both abstract and leaf (e.g., the abstract flag 316 cannot be set to ‘true’ whilst the leaf flag 318 is set to ‘true’).

As stated above, all elements of the executable graph-based model 100 are defined as nodes. This functionality is in part realized due to the use of a node type. The node type 308 of the node 302 is used to extend the functionality of the node 302. All nodes within the executable graph-based model 100 comprise a node type that defines additional data structures and implements additional executable functionality. A node type thus includes data structures and functionality that are common across all nodes that share that node type. The composition of a node with a node type therefore improves extensibility by allowing the generation of specialized node functionalities for specific application areas. Such extensibility is not present in prior art graph-based models. As illustrated in FIG. 3A, the node 302 and the node type 308 are one logical unit that is not separated in the context of an executing system at run-time (e.g., in the context of execution of an executable graph-based model).

FIG. 3A further shows the plurality of predetermined node types 326 which provides a non-exhaustive list of node types for the node type 308 associated with the node 302. The plurality of predetermined node types 326 include a vertex node type 328 and an edge node type 330. The vertex node type 328 (also referred to as a data node type or a value node type) includes common data structures and functionality related to the ‘things’ modeled in the graph (e.g., the data). The edge node type 330 includes common data structures and functionality related to joining two or more nodes. A node having the edge node type 330 may connect two or more nodes and thus the edge node type 330 constructs associations and connections between nodes (for example, objects or ‘things’) within the executable graph-based model 100. The edge node type 330 is not restricted to the number of nodes that can be associated or connected by a node having the edge node type 330. The data structures and functionality of the edge node type 330 thus define a hyper-edge which allows two or more nodes to be connected through a defined set of roles. A role defines a connective relationship between the two or more nodes, and hence, allows an edge node to connect two or more nodes such that the two or more nodes may have more than one relationship therebetween.

The plurality of predetermined node types 326 further includes the overlay node type 332 and the role node type 334. As will be described in more detail below, a node with the overlay node type 332 is used to extend the functionality of a node, such as the node 302, to incorporate processing logic. Unlike non-overlay nodes, an overlay node includes processing logic which determines the functionality of the overlay node. The processing logic of an overlay node includes a block of executable code, or instructions, which carries out one or more operations associated with the resource utilization in the overlay system 202. The block of executable code is pre-compiled code, code that requires interpretation at run-time, or a combination of both. Different overlay nodes provide different processing logic to realize different functionality.

The role node type 334 defines a connective relationship between two nodes, for example, an edge node and a first vertex node. A node with the role node type 334 defines a relationship without expressly defining the first vertex node to which the edge node connects. A number of roles (and thus a number of connections) that an edge node type can have is not limited.

The one or more attributes 310 correspond to the data associated with the node 302 (e.g., the data represented by the node 302 within the executable graph-based model 100 as handled by the data management module 238). Notably, a node in the executable graph-based model 100 that is not associated with data may not have any attributes. The one or more attributes 310 represent a complex data type. Each attribute of the one or more attributes 310 is composed of an attribute behavior. Attribute behavior may be one of a standard attribute behavior, a reference attribute behavior, a derived attribute behavior, and a complex attribute behavior. The attribute behavior of each attribute defines the behavior of the corresponding attribute. The attribute behavior of each attribute may be configured by associated attribute configurations. The attribute configurations are examples of attribute configuration extensions which are node configuration extensions (e.g., they are part of the one or more node configuration extensions 324 of the node 302 shown in FIG. 3A). The standard attribute behavior may be configured by a standard attribute configuration, the reference attribute behavior may be configured by a reference attribute configuration, the derived attribute behavior is configured by a derived attribute configuration, and the complex attribute behavior is configured by a complex attribute configuration.

The attribute behavior defines the behavior of the corresponding attribute. The standard attribute behavior is a behavior that allows read-write access to the data of the corresponding attribute. The reference attribute behavior is a behavior that allows read-write access to the data of the corresponding attribute but restricts possible values of the data to values defined by a reference data set. The reference attribute configuration associated with the reference attribute behavior includes appropriate information to obtain a reference data set of possible values. The derived attribute behavior is a behavior that allows read-only access to data of the corresponding attribute. Also, data of the corresponding attribute is derived from other data or information, within the executable graph-based model 100 in which an executable node of the corresponding attribute is used. The data is derived from one or more other attributes associated with the node or is derived from more complex expressions depending on the application area. In one embodiment, the derived attribute configuration (which is used to configure the derived attribute behavior) includes mathematical and/or other forms of expressions (e.g., regular expressions, templates, or the like) that are used to derive the data (value) of the corresponding attribute. The complex attribute behavior is a behavior that allows the corresponding attribute to act as either a standard attribute behavior if the data of the corresponding attribute is directly set, or a derived attribute behavior if the data of the corresponding attribute is not directly set.

As shown, the node 302 further includes the metadata 312 (e.g., data stored as a name, a count of processed messages, the time when the last message was processed, an average processing time required for processing a message, or the like) which is associated with either the node 302 or an attribute (for example, the one or more attributes 310) of the node 302.

The node configuration 314 provides a high degree of configurations for the different elements of the node 302. The node configuration 314 optionally includes the one or more node configuration strategies 322 and/or the one or more node configuration extensions 324 which are complex data types. An example of a concrete node configuration strategy is an ID strategy, associated with the configuration of the unique ID 304a of the node 302, which creates message source IDs. A further example of a concrete node configuration strategy is a versioning strategy, associated with the configuration of the version ID 304b of the node 302, which supports major and minor versioning (depending on the type of transactional change incurred by the node 302). The versioning strategy may be adapted to a native filing system of a user device hosting the overlay system 202 or a third-party data storage (for example, Snowflake®, or the like) associated with the overlay system 202.

FIG. 3B is a block diagram 300B that illustrates a generic structure of a run-time node 336 within the executable graph-based model 100, in accordance with an embodiment of the present disclosure. Referring to FIG. 3B, the run-time node 336 corresponds to the core structure of the executable graph-based model 100 and forms the foundational building block for all data and processing logic within the executable graph-based model 100. The run-time node 336 is shown to include a node template 338 and a node instance 340. The node instance 340 is generated according to the node template 338. The node template 338 forms a data structure for the node instance 340. The run-time node 336 shown in FIG. 3B is a compositional structure that is generated and executed, at run-time as part of the executable graph-based model 100. In other words, the node template 338 is defined ‘offline’ and the node instance 340 and the run-time node 336 are run-time structures that are dynamically generated during execution of the executable graph-based model 100.

The node template 338 comprises a predetermined node structure. Further, the node template 338 defines one or more rules that govern the generation of the node instance 340. The node instance 340 is an implementation of the node template 338. In other words, the node instance 340 is generated based on the predetermined node structure and the one or more rules of the node template 338. The node template 338 cannot be modified during the execution but may be modified during offline mode or at rest. During execution, only the node instance 340 of the run-time node 336 may be modified.

The node template 338 includes properties 342, a node type template 344, inheritance IDs 346, and a set of attribute templates 348. The node template 338 may optionally include metadata 352 and node configuration 354. The properties 342 of the node template 338 include a unique identifier (ID) 338a, a version ID 338b, a namespace 338c, a name 338d, and optionally include one or more icons 338e and a set of labels 338f The inheritance IDs 346 comprise an abstract flag 356, a leaf flag 358, and a root flag 360. The node configuration 354 optionally comprises one or more node configuration strategies 362 and/or one or more node configuration extensions 364. FIG. 3B further shows a plurality of predetermined node type templates 366. The plurality of predetermined node type templates 366 include a vertex node type template 368, an edge node type template 370, and an overlay node type template 372. Further, the node instance 340 includes a unique ID 374, a version ID 376, a node type instance 378, and a set of attribute instances 380. The node instance 340 may optionally include metadata 382. FIG. 3B further shows a plurality of predetermined node type instances 384. The plurality of predetermined node type instances 384 include a vertex node type instance 386, an edge node type instance 388, and an overlay node type instance 390.

The unique ID 338a is unique for each node template within the executable graph-based model 100. Similarly, the unique ID 374 is unique for each node instance within the executable graph-based model 100. The unique ID 338a and the unique ID 374 are used to register, manage, and reference the node template 338 and the node instance 340, respectively, within the overlay system 202. The version ID 338b of the node template 338 is incremented when the node template 338 undergoes transactional change. Similarly, the version ID 376 of the node instance 340 is incremented when the node instance 340 undergoes transactional change. The namespace 338c of the node template 338, along with the name 308d of the node template 338, is used to help organize node templates within the executable graph-based model 100. That is, the node template 338 is assigned a unique name 338d within the namespace 338c such that the name 338d of the node template 338 need not be unique within the entire executable graph-based model 100, only within the context of the namespace 338c to which the node template 338 is assigned. The node template 338 optionally comprises one or more icons 338e which are used to provide a visual representation of the node template 338. The one or more icons 338e can include icons at different resolutions and display contexts such that the visualization of the node is adapted to different display settings and contexts. The node template 338 also optionally comprises the set of labels 338f which are used to override the name 338d when the node template 338 is rendered or visualized.

The node template 338 supports the software development feature of multiple inheritance by maintaining references (not shown) to zero or more other node templates, which then act as the base of the node template 338. This allows the behavior and functionality of a node template to be extended or derived from one or more other node templates within an executable graph-based model. The node instance 340 likewise supports multiple inheritance because it is an instance representation of the node template 338. The multiple inheritance structure of the node instance 340 is, however, limited to the corresponding instance realization of the multiple inheritance structure defined by the node template 338, i.e., one node instance 340 is created and managed for each node template 338 defined in the inheritance hierarchy for a node instance of a node template.

The inheritance IDs 346 of the node template 338 indicate the inheritance-based information, which is applicable, or can be applicable, to the node template 338. The inheritance IDs 346 has a description that is similar to the inheritance IDs 306. The abstract flag 356 has a description that is similar to the abstract flag 316, the leaf flag 358 has a description that is similar to the leaf flag 318 and the root flag 360 has a description that is similar to the root flag 320.

All elements within the executable graph-based model 100 are defined as node templates or node instances. The functionality of the node template 338 and the node instance 340 are realized due to the use of the node type template 344 and the node type instance 378. The node type template 344 of the node template 338 is used to extend the functionality of the node template 338 by defining the standard set of capabilities, including data and associated behavior. The vertex node type template 368 (also referred to as a data node type) includes a template of common data structures and functionality related to the ‘things’ modeled in the graph (e.g., the data). The vertex node type instance 386 includes the common data structures and functionality related to the ‘things’ modeled in the graph based on the vertex node type template 368. The edge node type template 370 includes a template of common data structures and functionality related to joining two or more nodes. A node instance having the edge node type instance 388 may connect two or more nodes and thus the edge node type instance 388 constructs associations and connections between nodes (for example objects or ‘things’) within the executable graph-based model 100. The edge node type instance 388 is not restricted to the number of nodes that can be associated or connected by a node having the edge node type instance 388. The data structures and functionality of the edge node type instance 388 thus define a hyper-edge which allows two or more nodes to be connected through a defined set of roles. A role defines a connective relationship between the two or more nodes, and hence, allows an edge node to connect two or more nodes such that the two or more nodes may have more than one relationship therebetween. The plurality of predetermined node type templates 366 further includes the overlay node type template 372. The overlay node type template 372 is used to extend the functionality of a node template (e.g., the node template 338) to incorporate processing logic. Similarly, the overlay node type instance 390 is used to extend the functionality of a node instance (e.g., the node instance 340) to incorporate processing logic.

The set of attribute templates 348 corresponds to the data defined by the node template 338. For example, the set of attribute templates 348 may define the names and value types (e.g., integer, string, float, etc.) of one or more attributes but not the values of these attributes. The values of the set of attribute templates 348 may be defined by the set of attribute instances 380 of the node instance 340 through one or more values or instance values. For example, the node template 338 may define a string attribute ‘surname’ and the corresponding node instance 340 may assign the instance value ‘Bell-Richards’ to this string attribute. Each attribute instance of the set of attribute instances 380 is associated with an attribute template of the set of attribute templates 348. The node template 338 may define one or more default values for the set of attribute templates 348. The default values correspond to the values that the attributes take if no value is assigned. The metadata 352 (e.g., data stored as a name, value type, and value triplet) is associated with either the node template 338 or one or more of the set of attribute templates 348 of the node template 338. Similarly, the node instance 340 also optionally comprises the metadata 352 (e.g., data stored as a name, value type, and value triplet) which is associated with either the node instance 340 or one or more of the set of attribute instances 380.

The node configuration 354 provides a high degree of configurability for the different elements of a node template and/or node instance. An example of a concrete node configuration strategy is an ID strategy, associated with the configuration of the unique ID 338a of the node template 338. A further example of a concrete node configuration strategy is a versioning strategy, associated with the configuration of the version ID 338b of the node template 338 which supports major and minor versioning (depending on the type of transactional change incurred). The versioning strategy may be adapted to a native filing system of a user device hosting the overlay system 202 or a third-party data storage (for example, Snowflake®) associated with the overlay system 202.

Although it is provided that the node template 338 is associated with the node instance 340, the scope of the present disclosure is not limited to it. In other embodiments, the node template 338 may be further associated with two or more node instances where the two or more node instances correspond to two or more implementations of the node template 338.

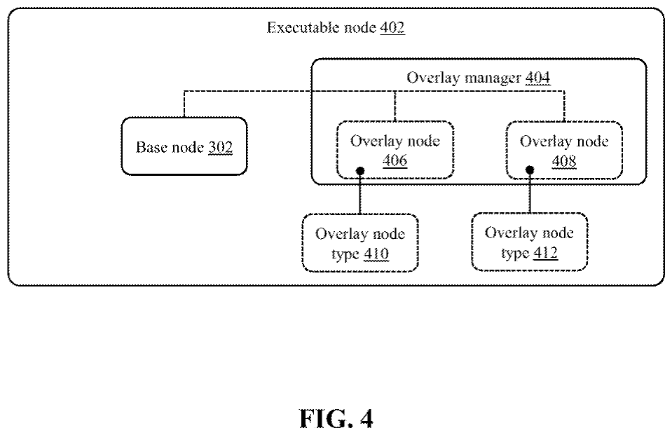

FIG. 4 is a block diagram that illustrates an executable node 402 within the executable graph-based model 100, in accordance with an embodiment of the present disclosure. Referring to FIG. 4, the executable node 402 is shown to include a base node (e.g., the node 302 or the run time node 336) and an overlay manager 404. For the sake of ongoing discussion, the base node corresponds to the node 302, and is hereinafter referred to as the “base node 302”. However, the functionality of the executable node 402 for the base node corresponding to the run time node 336 may be similar to that for the base node corresponding to the node 302.

The overlay manager 404 includes an overlay node 406 and an overlay node 408. The executable node 402 provides processing functionality (e.g., processing logic) to the base node 302 via one or more associated overlay nodes (for example, the overlay nodes 406 and 408). Beneficially, the data and processing capability of the base node 302 may be dynamically and significantly extended using the concept of an executable node (for example, the executable node 402).

As shown, the overlay nodes 406 and 408 have an overlay node type 410 and an overlay node type 412, respectively. Examples of an overlay node type include a message handler overlay node, a message publisher overlay node, an encryption overlay node, an audit overlay node, an obfuscation overlay node, a history overlay node, an analytics overlay node, a location overlay node, a data quality overlay node, or the like. Each overlay node, being a node, adheres to the generic structure of a base node described in conjunction with FIG. 3A.

A message handler overlay node is a node that includes processing logic for subscribing to one or more messages mapped to the corresponding executable node and processing the subscribed messages in conjunction with the corresponding node. The term ‘subscribe’ refers to an operation that is executed by a message handler overlay node for receiving a message from another executable node or the message management module 222 of the overlay system 202.

A message publisher overlay node is a node that includes processing logic for the generation and publication of one or more messages to be communicated by the corresponding executable node. The message publisher overlay node may be an extension of a base node. In an instance, when the message publisher overlay node is an extension of a base node, the message publisher overlay node may generate and publish messages that are to be communicated by the corresponding base node. In another instance, when the message publisher overlay node is an extension of another overlay node (e.g., a handler overlay node), the message publisher overlay node may generate and publish messages based on the processing of subscribed messages.

An encryption overlay node is a node that includes processing logic for encrypting the attribute values of the corresponding executable node. The encryption overlay node may be an extension of a base node.

An obfuscation overlay node is a node that includes processing logic for obfuscating the attribute values of the corresponding executable node. The obfuscation overlay node may be an extension of a base node.

An audit overlay node is a node that includes processing logic for maintaining a record of any changes to a corresponding executable node. The audit overlay node may be an extension of a base node.

A history overlay node is a node that includes processing logic for facilitating the creation, maintenance, and utilization of history associated with the corresponding executable node.

A location overlay node is a node that includes processing logic for holding a storage location information where the corresponding executable node is to be persisted.

A data quality overlay node is a node that includes processing logic for determining the quality value of data/information stored in the corresponding executable node.

An analytics overlay node is a node that includes processing logic for analyzing data (e.g., messages) being communicated within the overlay system 202. The analytics overlay node may be associated with one or more message nodes that are instantiated in the executable graph-based model 100 to represent messages associated with the overlay system 202.

The executable node 402 extends the base node 302 (or is a subtype of the base node 302) such that all the functionality and properties of the base node 302 are accessible to the executable node 402. The executable node 402 also dynamically extends the functionality of the base node 302 by associating the overlay nodes maintained by the overlay manager 404 with the base node 302. The executable node 402 may thus be considered a composition of the base node 302, the overlay node 406, and the overlay node 408. The executable node 402 may be alternatively referred to as a node with overlay. Therefore, the executable node 402 acts as a decorator of the base node 302 adding the functionality of the overlay manager 404 to the base node 302.

Although, the executable node 402 is shown to include the overlay nodes 406 and 408, in other embodiments, the executable node 402 may include any number of overlay nodes, without deviating from the scope of the present disclosure.

It will be apparent to a person skilled in the art that the base node 302 refers to any suitable node within the executable graph-based model 100. As such, the base node 302 may be a node having a type such as a vertex node type, an edge node type, or the like.

The overlay manager 404 registers and maintains one or more overlay nodes (such as the overlay nodes 406 and 408) associated with the base node 302. The assignment of the overlay node 406 to the base node 302 (via the overlay manager 404) endows the base node 302 with processing logic and executable functionality defined within the overlay node 406. Similarly, the assignment of the overlay node 408 to the base node 302 (via the overlay manager 404) endows the base node 302 with processing logic and executable functionality defined within the overlay node 408.

Extending the functionality of a base node through one or more overlay nodes is at the heart of the overlay system 202. As illustrated in FIGS. 3A and 3B, the data (e.g., a vertex node as represented by the base node 302 in FIG. 4) and the functionality that acts upon that data (e.g., an overlay node) can be separated and independently maintained offline, but at run-time, an association between the data node and the overlay node is determined and an executable node is generated (e.g., the executable node 402 shown in FIG. 4).

An overlay node, such as the overlay node 406, is not bound to a single executable node or a single executable graph-based model (unlike nodes that have non-overlay node types). This allows overlay nodes to be centrally managed and reused across multiple instances of executable graph-based models. Notably, a node (for example, a data node, an executable node, and an overlay node) may be extended by way of overlays. Further, each overlay node may be extended to have one or more overlays. Such overlays may be termed chaining overlays.

Unlike non-overlay nodes, an overlay node includes processing logic (not shown in FIG. 4) which determines the functionality of the overlay node. The processing logic of an overlay node includes a block of executable code, or instructions, which carries out one or more operations associated with facilitating resource utilization within the overlay system 202. The block of executable code is pre-compiled code, code that requires interpretation at run-time, or a combination of both. Different overlay nodes provide different processing logic to realize different functionality.

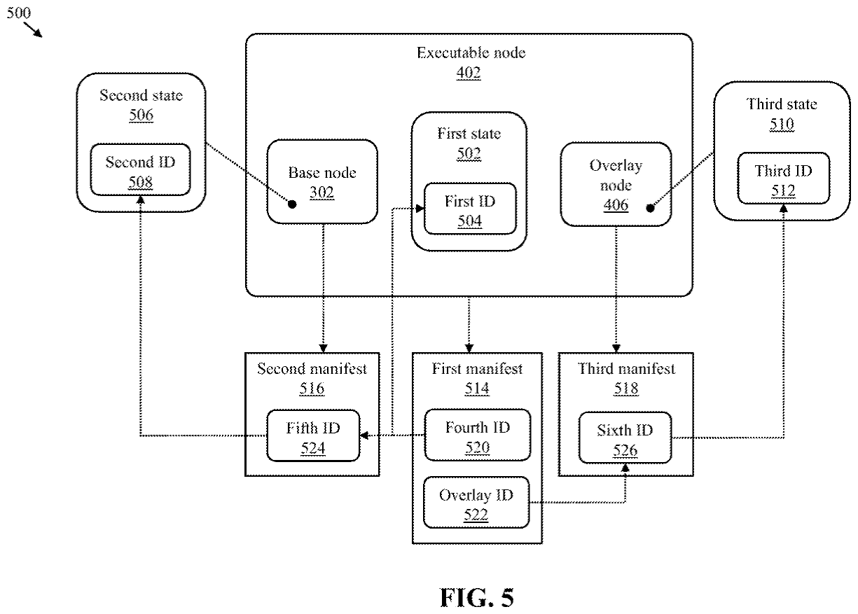

The data and the processing logic associated with one or more overlays of an executable node (for example, the executable node 402) are persistent. The persistent nature of the data and the processing logic are described in detail in conjunction with FIG. 5.

FIG. 5 is a block diagram 500 that illustrates a composition of the executable node 402 that enables persistent storage of data and the processing logic associated therewith, in accordance with an embodiment of the present disclosure.

As described in conjunction with FIG. 4, the executable node 402 includes the base node 302 and one or more overlay nodes (e.g., the overlay nodes 406 and 408). For the brevity of the ongoing description, the persistent storage is explained for the executable node 402 including only the overlay node 406. One or more operations performed for ensuring the persistence of the overlay node 406 may be performed for the overlay node 408 as well.

The executable node 402 has a first state 502 having a first ID 504. The base node 302 has a second state 506 having a second ID 508, and the overlay node 406 has a third state 510 having a third ID 512. A manifest (for example, first through third manifests 514-518) is generated for each of the base node 302, the executable node 402, and the overlay node 406. In an embodiment, the manifests may be generated by the storage management module 218. The first manifest 514 is associated with the executable node 402 and has a fourth ID 520 and an overlay ID 522. The second manifest 516 is associated with the base node 302 and has a fifth ID 524. The third manifest 518 is associated with the overlay node 406 and has a sixth ID 526. Further, the manifests are stored at respective storage locations that may be centralized or distributed storage locations associated with the overlay system 202. The manifests may be stored by the storage management module 218.

The first state 502 of the executable node 402 includes data required to reconstruct the executable node 402 (e.g., attributes, properties, etc.). The first state 502 of the executable node 402 is persistently stored along with the first ID 504. The first manifest 514 is generated for the executable node 402 and has (i) the fourth ID 620 (which is the same as the first ID 504), (ii) the storage location of the first state 502 of the executable node 402, and (iii) the overlay ID 522. Notably, the fourth ID 520 is the same as the first ID 504 and the fifth ID 524, hence, the first manifest 514 includes the ID of the state of the base node 302 and the executable node 402. Further, the overlay ID 522 is the same as the sixth ID 526 of the state of the overlay node 406. Therefore, the first manifest 514 may be used to identify and retrieve the states of the base node 302, the executable node 402, and the overlay node 406. Subsequently, the retrieved states may be used to reconstruct the executable node 402 and the overlay node 406. In an instance, the executable node 402 may be further extended to include additional overlay nodes. In such an instance, the first manifest 514 may include state IDs of the additional overlay nodes as well. A first manifest state (not shown) is then generated for the first manifest 514 and persistently stored along with the fourth ID 520.

The second state 506 of the base node 302 includes data required to reconstruct the base node 302 (e.g., attributes, properties, etc.) and is persistently stored along with the second ID 508. The second manifest 516 is generated for the base node 302 and has (i) the fifth ID 524 and (ii) the storage location of the second state 506 of the base node 302. The second ID 508 of the second state 506 and the fifth ID 524 of the second manifest 516 are the same as the first ID 504 of the first state 502 of the executable node 402 (which is also the same as the fourth ID 520 of the first manifest 514 of the executable node 402). As mentioned above, along with the first state 502, the first manifest 514 may also be used to identify and retrieve the second manifest 516 which in turn may be used to identify the second state 506 of the base node 302. A second manifest state (not shown) is then generated for the second manifest 516 and persistently stored along with the fifth ID 524. Thus, the states, manifests, and manifest states for the executable node 402 and the base node 302 include the same, shared, ID. A shared ID can be used in this instance because the states, manifests, and manifest states are stored separately. The separate storage of the states, manifests, and manifest states exhibit a distributed architecture of the overlay system 202.

The third state 510 of the overlay node 406 includes data required to reconstruct the overlay node 406 (e.g., attributes, properties, processing logic, etc.) and is persistently stored along with the third ID 512. The third manifest 518 is generated for the overlay node 406 and includes the sixth ID 526, which is the same as the third ID 512. Therefore, the first manifest 514 may be further used to identify and retrieve the third manifest 518 which in turn may be used to identify and retrieve the third state 510 of the overlay node 406. A third manifest state (not shown) is then generated for the third manifest 518 and is persistently stored along with the sixth ID 526.

In operation, when the executable node 402 is to be loaded, the transaction module 208, in conjunction with the storage management module 218, may execute one or more operations to retrieve the first manifest state stored at a known storage location. Based on the first manifest state, the storage management module 218 may re-construct the first manifest 514 which includes the fourth ID 520 which is the same as the fifth ID 524 of the second manifest 516. Based on the fifth ID 524, the storage management module 218 may identify the second manifest state and may generate the second manifest 516 based on which the second state 506 is identified. Subsequently, the base node 302 is loaded and the storage management module 218 may determine that the base node 302 is a node with overlay. Based on the fourth ID 520 (that is the same as the first ID 504 of the first state 502 of the executable node 402) of the first manifest 514, the first state 502 is identified and retrieved. Subsequently, the executable node 402 is loaded. Moreover, based on the overlay ID 522 (that is the same as the sixth ID 526 of the third manifest 518) of the first manifest 514, the third manifest state is identified and the third manifest 518 is generated. Subsequently, based on the sixth ID 526 (that is the same as the third ID of the third state) of the third manifest 518, the third state 510 is identified and retrieved. Based on the third state 510, the overlay node 406 is reconstructed and loaded in the executable graph-based model 100.

In some embodiments, the overlay node 406 may not be loaded in case it is not required for executing the operation associated with the set of stimuli 232. The loaded executable node 402 and the overlay node 406 may be unloaded in case they remain unused for a first predefined time period, whereas one or more executable nodes that are used at least once during the first predefined time period may remain loaded in the executable graph-based model 100. In some embodiments, the data and processing logic associated with a loaded executable node and/or overlay node may be transferred to a local memory of the overlay system 202, if the data and the processing logic remain unused for a second predefined time period. Further, the data and the processing logic associated with the executable node/overlay node are transferred to an external storage from the local memory in case the executable node/overlay node remains unused for a third predefined time period. The third predefined time period is greater than the second predefined time period, and the second predefined time period is greater than the first predefined time period. The term unloading refers to storing a state of a node with a current version of data and processing logic associated therewith at a storage location that is pointed by the corresponding manifest.

An executable graph-based model (for example, the executable graph-based model 100) may be stored (and loaded) using the above-described composition. Beneficially, each component is stored separately thereby allowing a user to maintain and store their data independently of the storage of the structure and functionality of the executable graph-based model 100.

Notably, all manifest states are stored together at a storage location that is known to the storage management module 218. Such centralized storage of the manifest states ensures that node states associated therewith are easily accessible.

Although FIG. 5 illustrates only a single overlay node, in other embodiments, the executable node may include additional or different overlay nodes. Further, only those overlay nodes that are required for responding to the set of stimuli 232 may be loaded. The overlay system 202 described above may be used to implement systems and methods for resource utilization in overlay system 202.

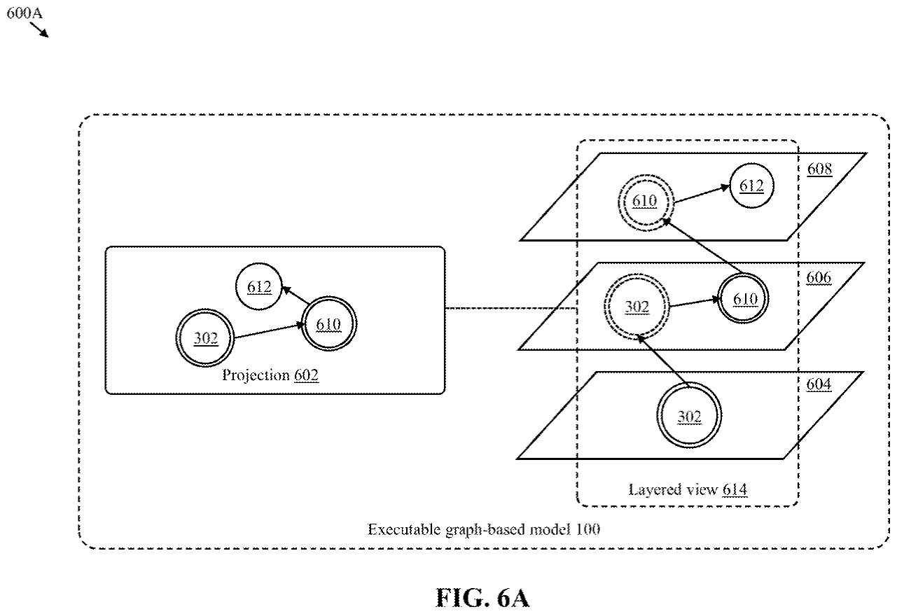

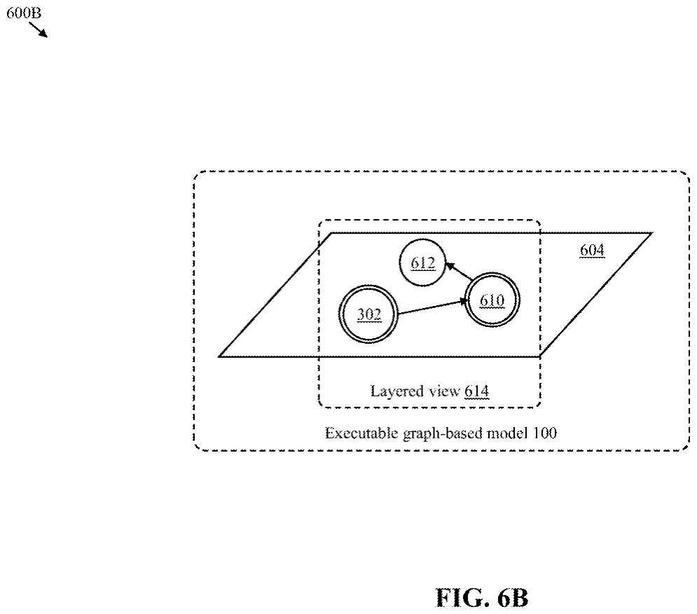

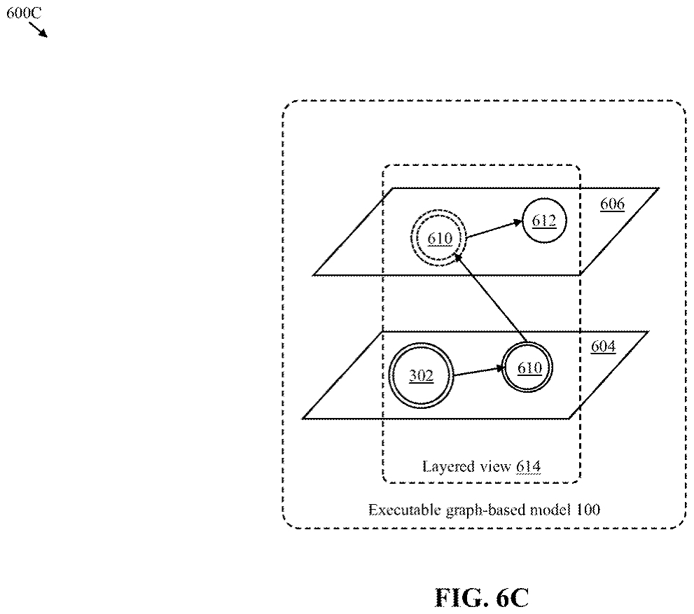

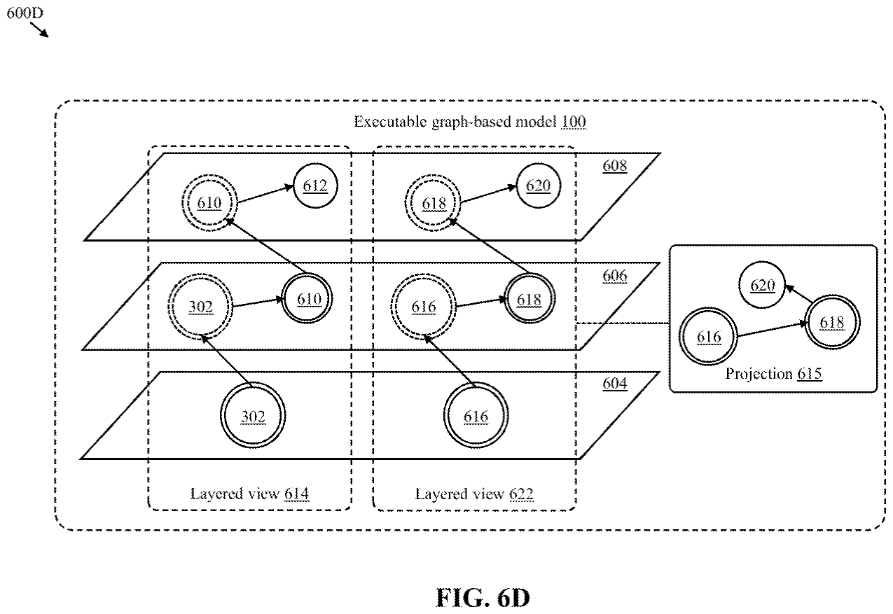

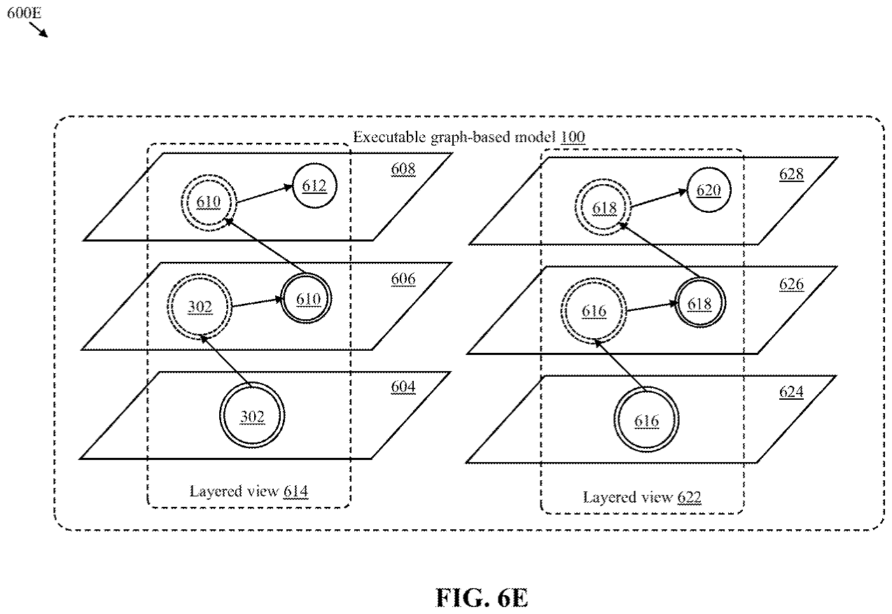

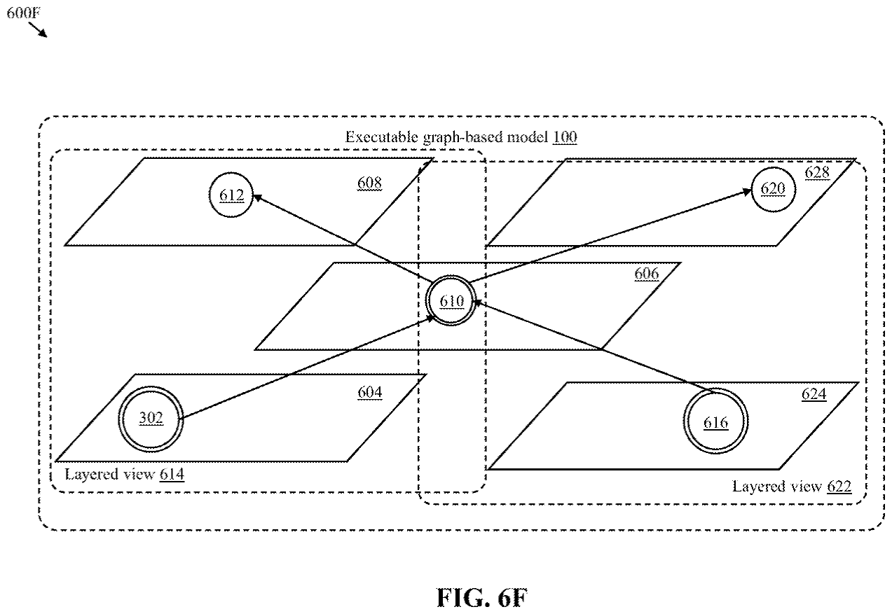

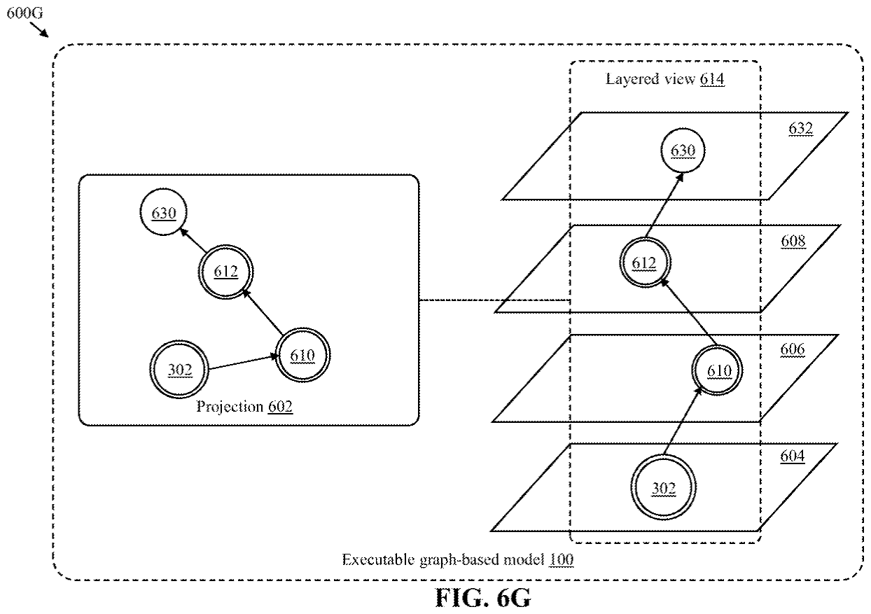

FIG. 6A is a schematic diagram 600A that illustrates resource utilization in the overlay system 202 using projections, in accordance with an embodiment of the present disclosure. Referring to FIG. 6A, a projection 602 is illustrated in accordance with an embodiment of the present disclosure. The secondary storage element associated with the storage management module 218 is configured to store a first plurality of nodes associated with the overlay system 202. Examples of the secondary storage element include hard disk drives, solid-state drives, optical disks, or the like. The first plurality of nodes is arranged in the form of a plurality of node groups (such as a subgraph or a container). A node group may correspond to a logical grouping of one or more associated nodes of the first plurality of nodes. Further, the primary storage element associated with the memory management module 216 is configured to store the executable graph-based model 100.

The executable graph-based model 100 may include a first set of node layers. The first set of node layers accommodates one or more nodes associated with the execution of an operation associated with the overlay system 202. In one embodiment, the first set of node layers may include at least one of a group consisting of a vertex node layer, an edge node layer, at least a first type of overlay node layer, an index node layer, a history node layer, a message node layer, and a role node layer. Further, the first type of overlay node layer may correspond to one of a group consisting of a message handler overlay node layer, a message publisher overlay node layer, an encryption overlay node layer, an audit overlay node layer, an obfuscation overlay node layer, a history overlay node layer, an analytics overlay node layer, a location overlay node layer, and a data quality overlay node layer. For the sake of ongoing discussion, the first set of node layers is shown to include a node layer 604, a node layer 606, and a node layer 608 in FIG. 6A. Each node layer of the first set of node layers may be associated with a node layer ID.

In operation, the stimuli management module 212 is configured to receive a first stimulus of the set of stimuli 232. The first stimulus may correspond to a command or a query. Further, the stimuli management module 212, in conjunction with, the context module 210, the controller module 206, and the projection management module 224, may be configured to identify a second plurality of nodes associated with the first stimulus. The second plurality of nodes are required for stimulus processing of the first stimulus. The second plurality of nodes are identified from the first plurality of nodes that are stored in the storage management module 218. In other words, the stimuli management module 212, in conjunction with the context module 210, the controller module 206, and the projection management module 224, may identify, from the plurality of node groups, one or more node groups based on a first context of the first stimulus. Further, the controller module 206, in conjunction with the projection management module 224, may be configured to extract, for the processing of the first stimulus, one or more nodes from each identified node group, such that the one or more nodes extracted from each identified node group constitute the second plurality of nodes.

The second plurality of nodes include the base node 302, a base node 610, and a base node 612. The base node 610 and the base node 612 are structurally and functionally similar to the base node 302 that is described in FIG. 3A.

A node type of the base nodes 302, 610, and 612 may correspond to a first node type, a second node type, and a third node type, respectively. That is to say, each node of the first plurality of nodes may have a node type that corresponds to one of a group consisting of a vertex node type, an edge node type, at least a first overlay node type, an index node type, a history node type, a message node type, and a role node type. Further, the first overlay node type may correspond to one of a group consisting of a message handler overlay node type, a message publisher overlay node type, an encryption overlay node type, an audit overlay node type, an obfuscation overlay node type, a history overlay node type, an analytics overlay node type, a location overlay node type, and a data quality overlay node type. For the sake of ongoing discussion, it is assumed that base node 302 corresponds to a vertex node and the base nodes 610 and 612 correspond to two different types of overlay nodes. Thus, the base node 302 is hereinafter referred to as “the vertex node 302” and the base nodes 610 and 612 are hereinafter referred to as “the overlay node 610” and “the overlay node 612”, respectively. Additionally, the overlay node 610 is an overlay of the vertex node 302, whereas the overlay node 612 is an overlay of the overlay node 610.

The controller module 206, in conjunction with the projection management module 224, may be further configured to determine an association between each node of the second plurality of nodes and a node layer of the first set of node layers based on the first context of the first stimulus. Further, the controller module 206, in conjunction with the projection management module 224, may be configured to load the second plurality of nodes into the executable graph-based model 100. As shown in FIG. 6A, the vertex node 302 is loaded into the node layer 604, the overlay node 610 is loaded into the node layer 606, and the overlay node 612 is loaded into the node layer 608 during the loading of the second plurality of nodes into the executable graph-based model 100. The loading of the second plurality of nodes into the first set of node layers is a function of an association between one or more nodes of the second plurality of nodes.

The second plurality of nodes may be loaded simultaneously into the executable graph-based model 100. That is to say, each node of the second plurality of nodes is loaded parallelly such that the start and end of the loading are the same for each node. The second plurality of nodes, loaded into the executable graph-based model 100, constitute the projection 602. In other words, the vertex node 302, the overlay node 610, and the overlay node 612 constitute the projection 602. Each node of the second plurality of nodes is loaded into the executable graph-based model 100 with corresponding data and processing logic. The projection management module 224, in conjunction with the controller module 206, may be further configured to execute an operation associated with the first stimulus based on the second plurality of nodes of the projection 602. Thus, the second plurality of nodes that are required for the execution of the operation associated with the first stimulus are loaded simultaneously into the executable graph-based model 100 upon receiving the first stimulus. As a result, the resource of the primary storage element is efficiently utilized. Additionally, as the second plurality of nodes are loaded simultaneously into the executable graph-based model 100, the latency involved with the execution of the operation associated with the first stimulus is reduced.

FIG. 6A further illustrates a layered view 614 of the projection 602. The layered view 614 of the projection 602 illustrates the vertex node 302 in the node layer 604, the overlay node 610 in the node layer 606, and the overlay node 612 in the node layer 608. In an example, the first context of the first stimulus may indicate the node layer IDs of the first set of node layers. Thus, the node layer IDs of the first set of node layers may be utilized to load the second plurality of nodes into the first set of node layers. The layered view 614 of the projection 602 further illustrates the vertex node 302 represented in a concentric dotted circle in the node layer 606, and the overlay node 610 represented in a concentric dotted circle in the node layer 608. The vertex node 302 and the overlay node 610 represented in concentric dotted circles, refer to a reference of the vertex node 302 and a reference of the overlay node 610, respectively.

The references to the vertex node 302 and the overlay node 610 are illustrated in the node layers 606 and 608, respectively, to indicate that the overlay node 610 and the overlay node 612 are associated with the vertex node 302 and the overlay node 610, respectively. In an example, the overlay node 610 may be loaded into the node layer 606 without the vertex node 302 being loaded into the node layer 604. In such a scenario, based on the reference of the vertex node 302 in the node layer 606, the vertex node 302 is loaded into the node layer 604, as the overlay node 610 cannot be executed without the vertex node 302.

The projection 602 or a portion thereof may be unloaded from the executable graph-based model 100 to free up resources therein. The unloading may be implemented in various ways and for different scenarios.

In one embodiment, the controller module 206, in conjunction with the projection management module 224, may be further configured to unload one or more of the vertex node 302, the overlay node 610, and the overlay node 612, from the executable graph-based model 100, based on the execution of the operation associated with the first stimulus. In an example, the vertex node 302 is unloaded from the executable graph-based model 100 based on the utilization of the vertex node 302. In such a scenario, the overlay node 610 and the overlay node 612 may also be unloaded from the executable graph-based model 100 as the overlay node 610 is dependent on the vertex node 302 and the overlay node 612 is dependent on the overlay node 610. In an alternate embodiment, as the overlay node 610 is dependent on the vertex node 302, the vertex node 302 may be reloaded into the executable graph-based model 100 prior to utilization of the overlay node 610 for another operation.

In another embodiment, the controller module 206, in conjunction with the projection management module 224, may be further configured to unload one or more of the node layers 604, 606, and 608 based on the completion of the utilization of the one or more of the node layers 604, 606, and 608, respectively, for the execution of the operation associated with the first stimulus. In other words, the controller module 206, in conjunction with the projection management module 224, may be configured to unload at least a first node layer (i.e., the node layer 604) of the first set of node layers based on the utilization of the first node layer for the execution of the operation associated with the first stimulus. The unloading of the node layer 604 results in the unloading of the vertex node 302, the unloading of the node layer 606 results in the unloading of the overlay node 610, and the unloading of the node layer 608 results in the unloading of overlay node 612. The node layer 606 is dependent on the node layer 604 as the node layer 606 includes the overlay node 610 which is the overlay of the vertex node 302 loaded in the node layer 604. Thus, if the node layer 604 is unloaded from the executable graph-based model 100, the controller module 206, in conjunction with the projection management module 224, may be further configured to unload the node layer 606 based on the dependency associated therewith. That is to say, as the overlay node 610 cannot be executed without the vertex node 302, the unloading of the vertex node 302 also results in the unloading of the overlay node 610 from the executable graph-based model 100. In other words, a second node layer, of the first set of node layers, is dependent on the first node layer, and the controller module 206, in conjunction with the projection management module 224, may be further configured to unload the second node layer along with the first node layer based on the dependency associated therewith. Further, as the overlay node 612 is the overlay of the overlay node 610, the unloading of the overlay node 610 further results in the unloading of the overlay node 612 from the executable graph-based model 100.

In another embodiment, the controller module 206, in conjunction with the projection management module 224, may be further configured to unload the projection 602 in its entirety, from the executable graph-based model 100, based on the completion of the execution of the operation associated with the first stimulus. Unloading of the projection 602 corresponds to the unloading of the vertex node 302, the overlay node 610, and the overlay node 612 (i.e., the second plurality of nodes) from the executable graph-based model 100. The second plurality of nodes are unloaded from the primary storage element and loaded into the secondary storage element. In such a scenario, the second plurality of nodes of the projection 602 are unloaded simultaneously.

In another embodiment, the controller module 206, in conjunction with the projection management module 224, may be further configured to unload, from the executable graph-based model 100, at least the vertex node 302 based on the lapse of a predetermined time duration after the execution of the operation associated with the first stimulus. Particularly, each node of the second plurality of nodes loaded into the executable graph-based model 100 is associated with a predetermined time period for which the corresponding node can be retained in the executable graph-based model 100 after the execution of the associated operation. Thus, upon the lapse of the predetermined time period, corresponding nodes of the second plurality of nodes are unloaded from the executable graph-based model 100.

Although it is described that the executable graph-based model 100 includes the first set of node layers prior to the reception of the first stimulus, the scope of the present disclosure is not limited to it. In other embodiments, the controller module 206, in conjunction with the projection management module 224, may be further configured to create the first set of node layers in the executable graph-based model 100 based on the determination of the association of each node of the second plurality of node with one node layer of the first set of node layers.

Although it is illustrated that the second plurality of nodes include three nodes where each node corresponds to a different node type, the scope of the present disclosure is not limited to it. In other embodiments, the second plurality of nodes may include one or more sets of nodes with each of the one or more sets of nodes having a different node type. In such a scenario, the loading of the second plurality of nodes corresponds to the loading of each set of nodes into one node layer of the first set of node layers. In an example, a set of node layers of the second plurality of nodes may be loaded into at least the node layer 604 of the first set of node layers.

FIG. 6B is a schematic diagram 600B that illustrates resource utilization in the overlay system 202 using projections, in accordance with another embodiment of the present disclosure. Referring to FIG. 6B, the layered view 614 of the projection 602 is illustrated in accordance with a different embodiment of the present disclosure. The layered view 614 of the projection 602 illustrates the second plurality of nodes in a single node layer (e.g., the node layer 604) of the first set of node layers. In other words, the vertex node 302, the overlay node 610, and the overlay node 612 are loaded into the node layer 604. In other words, the controller module 206, in conjunction with the projection management module 224, may load the second plurality of nodes into the node layer 604 based on the determined association between each node of the second plurality nodes with the node layer 604. In an example, the first context may be indicative of the loading of the second plurality of nodes into the node layer 604, thereby resulting in the loading of the second plurality of nodes into the node layer 604.

FIG. 6C is a schematic diagram 600C that illustrates resource utilization in the overlay system 202 using projections, in accordance with another embodiment of the present disclosure. Referring to FIG. 6C, the layered view 614 of the projection 602 is illustrated in accordance with another different embodiment of the present disclosure. In the embodiment of FIG. 6C, the layered view 614 of the projection 602 illustrates the vertex node 302 and the overlay node 610 in the node layer 604, and the overlay node 612 in the node layer 606. In other words, the controller module 206, in conjunction with the projection management module 224, may load the vertex node 302 and the overlay node 610 into one node layer (e.g., the node layer 604), and the overlay node 612 into a different node layer (e.g., the node layer 606) based on the determined association between each node of the second plurality nodes with a node layer of the first set of node layers. That is to say, the vertex node 302 and the overlay node 610 which have the first node type and the second node type, respectively, are loaded into one node layer and the overlay node 612 that has the third node type is loaded into another node layer. In other words, the second plurality of nodes include at least a first set of nodes, a second set of nodes, and a third set of nodes. The first set of nodes includes the base node 302, the second set of nodes includes the overlay node 610, and the third set of nodes includes the overlay node 612. Further, each node of the first set of nodes has the first node type, each node of the second set of nodes has the second node type, and each node of the third set of nodes has the third node type, and the first node type, the second node type, and the third node type are different. Additionally, the loading of the second plurality of nodes corresponds to the loading of the first set of nodes and the second set of nodes into one node layer and the loading of the third set of nodes into a different node layer of the first set of node layers.

In an example, the first context may be indicative of the loading of the vertex node 302 and the overlay node 610 in the node layer 604, and the overlay node 612 in the node layer 606, thereby resulting in the loading of the vertex node 302 and the overlay node 610 in the node layer 604, and the overlay node 612 in the node layer 606. The overlay node 610 represented in concentric dotted circles, refer to the reference of the overlay node 610. The reference to the overlay node 610 is illustrated in the node layer 606 so as to indicate that the overlay node 612 is associated with the overlay node 610. In an example, the overlay node 612 may be loaded into the node layer 606 without loading the vertex node 302 and the overlay node 610 into the node layer 604. In such a scenario, based on the reference of the overlay node 610 in the node layer 606, the vertex node 302 and the overlay node 610 may be loaded into the node layer 604, as the overlay node 612 cannot be executed without the vertex node 302 and the overlay node 610.

FIG. 6D is a schematic diagram 600D that illustrates resource utilization in the overlay system 202 using projections, in accordance with another embodiment of the present disclosure. Referring to FIG. 6D, the projection 602 may be loaded into the node layers 604, 606, and 608 in a manner similar to that described in FIG. 6A. Further, the stimuli management module 212 may be further configured to receive a second stimulus of the set of stimuli 232 after the execution of the operation associated with the first stimulus. The second stimulus may correspond to a command or a query.

The stimuli management module 212, in conjunction with the context module 210, the controller module 206, and the projection management module 224, may be configured to identify a third plurality of nodes associated with the processing of the second stimulus. The third plurality of nodes are identified from the first plurality of nodes that are stored in the secondary storage element associated with the storage management module 218. Particularly, the stimuli management module 212, in conjunction with, the context module 210, the controller module 206, and the projection management module 224, may identify, from the plurality of node groups, one or more node groups based on a second context of the second stimulus. Further, the controller module 206, in conjunction with the projection management module 224, may extract, for the processing of the second stimulus, one or more nodes from each identified node group, such that the one or more nodes extracted from each identified node group constitute the third plurality of nodes.

The controller module 206, in conjunction with the projection management module 224, may be further configured to determine an association between each node of the third plurality nodes and a node layer of the first set of node layers based on the second context of the second stimulus. Further, the controller module 206, in conjunction with the projection management module 224, may be configured to load the third plurality of nodes into the executable graph-based model 100. The third plurality of nodes are loaded simultaneously into the executable graph-based model 100. The third plurality of nodes, loaded into the executable graph-based model 100, constitute a projection 615. The projection management module 224, in conjunction with the controller module 206, may be further configured to execute an operation associated with the second stimulus based on the third plurality of nodes of the projection 615.

The third plurality of nodes that constitute the projection 615 include a base node 616, a base node 618, and a base node 620. The base nodes 616, 618, and 620 are structurally and functionally similar to the base node 302 that is described in conjunction with FIG. 3A. The base nodes 616, 618, and 620 may correspond to different types of nodes. For the sake of brevity, it is assumed that the base node 616 corresponds to a vertex node and the base nodes 618 and 620 correspond to two different types of overlay nodes. Thus, the base node 616 is hereinafter referred to as “the vertex node 616” and the base nodes 618 and 620 are hereinafter referred to as “the overlay node 618” and “the overlay node 620”, respectively. Additionally, the overlay node 618 is an overlay of the vertex node 616, and the overlay node 620 is an overlay of the overlay node 618.

FIG. 6D further illustrates a layered view 622 of the projection 615. The layered view 622 of the projection 615 illustrates the vertex node 616 in the node layer 604, the overlay node 618 in the node layer 606, and the overlay node 620 in the node layer 608. The vertex node 616 is loaded into the node layer 604, the overlay node 618 is loaded into the node layer 606, and the overlay node 620 is loaded into the node layer 608 during the loading of the third plurality of nodes into the executable graph-based model 100. The layered view 622 of the projection 615 may be implemented in a manner similar to that of the layered view 614 of the projection 602.

In some embodiments, the projection 602 and the projection 615 are present in the executable graph-based model 100 simultaneously. This is possible when the primary storage element associated with the memory management module 216 has sufficient resources to store both the projections 602 and 615. However, in some other embodiments, during the processing of the second stimulus, the controller module 206, in conjunction with the projection management module 224, may be further configured to determine that the resource of the primary storage element associated with the memory management module 216 is exhausted. That is to say, the controller module 206, in conjunction with the projection management module 224, may determine that the resource of the primary storage element associated with the memory management module 216 is exhausted upon the determination of the association between each node of the third plurality nodes with a node layer of the first set of node layers. In such a scenario, the projection 602 or a portion thereof may be required to be unloaded from the executable graph-based model 100 to free up the resource for the loading of the projection 615. For example, the controller module 206, in conjunction with the projection management module 224, may be configured to unload one or more nodes of the projection 602 from the executable graph-based model 100 based on the determination that the resource of the primary storage element associated with the memory management module 216 is exhausted. The one or more nodes of the projection 602 are simultaneously unloaded. Further, the third plurality of nodes is loaded into the executable graph-based model 100 based on the unloading of the one or more nodes of the projection 602. Thus, the unloading of the one or more nodes of the projection 602 results in the allocation of resources for the loading of the third plurality of nodes.

In other embodiments, another projection (not shown) may be present in the executable graph-based model 100 prior to the second stimulus. In such embodiments, one or more nodes of the other projection may be loaded into each node layer of the first set of node layers. Further, to free up the resource for the loading of the projection 615, an entire node layer (e.g., the node layer 604) may have to be unloaded. In such a scenario, the controller module 206, in conjunction with the projection management module 224, may unload the node layer 604 from the executable graph-based model 100 based on the determination that the resource of the primary storage element is exhausted during the processing of the second stimulus. The unloading of the node layer 604 results in the unloading of a set of nodes (e.g., the vertex node 302) of the projection 602 and one or more nodes of the other projection that are loaded in the node layer 604. Also, the nodes are unloaded simultaneously.

In the above-described embodiment, the node layers 604, 606, and 608 may be unloaded from the executable graph-based model 100 after the completion of the execution of the operation associated with the second stimulus for efficient resource utilization. In such a scenario, the unloading of the node layer 604 results in the unloading of the vertex nodes 302 and 616. Further, unloading of the node layer 606 results in the unloading of the overlay nodes 610 and 618. Similarly, unloading of the node layer 608 results in unloading of the overlay nodes 612 and 620.

FIG. 6E is a schematic diagram 600E that illustrates resource utilization in the overlay system 202 using projections, in accordance with another embodiment of the present disclosure. Referring to FIG. 6E, the layered view 614 of the projection 602 and the layered view 622 of the projection 615 in accordance with another embodiment of the present disclosure are illustrated. Although it is illustrated in FIG. 6D that the third plurality of nodes are loaded into the first set of node layers, the scope of the present disclosure is not limited to it. In other embodiments, the third plurality of nodes may be associated with a different set of node layers (e.g., a second set of node layers) of the executable graph-based model 100. In such a scenario, the controller module 206, in conjunction with the projection management module 224, may determine an association between each node of the third plurality nodes and a node layer of the second set of node layers. The second set of node layers is shown to include node layers 624, 626, and 628. In such embodiments, the projection management module 224, in conjunction with the controller module 206, based on the determined association, may be further configured to load the vertex node 616 into the node layer 624, the overlay node 618 into the node layer 626, and the overlay node 620 into the node layer 628. The vertex node 616, the overlay node 618, and the overlay node 620, loaded into the second set of node layers, constitute the projection 615. The vertex node 616 and the overlay node 618 represented in concentric dotted circles in node layers 626 and 628, refer to a reference of the vertex node 616 and a reference of the overlay node 618, respectively. The projection management module 224, in conjunction with the controller module 206, may be further configured to execute the operation associated with the second stimulus based on the third plurality of nodes of the projection 615 that are loaded into the second set of node layers.

In some embodiments, during the processing of the second stimulus, it may be determined that resource of the primary storage element associated with the memory management module 216 is exhausted. In such a scenario, the projection 602 or a portion thereof may be required to be unloaded from the executable graph-based model 100 to free up the resource for the loading of the projection 615. The unloading of the projection 602 or a portion thereof may be executed in a similar manner as described above.

Although it is illustrated that the first set of node layers and the second set of node layers include three node layers, the scope of the present disclosure is not limited to it. In other embodiments, each of the first and second sets of node layers may include less than or more than three node layers, without deviating from the scope of the present disclosure. In such embodiments, each node layer of the first set of node layers and each node layer of the second set of node layers may have a unique node-layer-type. Further, each node layer, of the first set of node layers, is loaded with a set of nodes, of the second plurality of nodes, having a same node-type as the node-layer-type of the corresponding node layer. Similarly, each node layer, of the second set of node layers, is loaded with a set of nodes, of the third plurality of nodes, having a same node-type as the node-layer-type of the corresponding node layer.

FIG. 6F is a schematic diagram 600F that illustrates resource utilization in the overlay system 202 using projections, in accordance with another embodiment of the present disclosure. Referring to FIG. 6F, the layered view 614 of the projection 602 and the layered view 622 of the projection 615 in accordance with another embodiment of the present disclosure are illustrated. The second plurality of nodes of the projection 602 and the third plurality of nodes of the projection 615, may comprise at least a common set of nodes. Thus, the first set of node layers and the second set of node layers may comprise at least one common node layer that comprises the common set of nodes. In the embodiment of FIG. 6F, the second plurality of nodes of the projection 602 and the third plurality of nodes of the projection 615 comprise the overlay node 610 as a common node. Thus, both the first set of node layers and the second set of node layers comprise the node layer 606 into which the overlay node 610 is loaded as the common node layer.

In operation, the second plurality of nodes that include the vertex node 302, the overlay node 610, and the overlay node 612 are loaded into the executable graph-based model 100 based on the first stimulus. Further, upon the reception of the second stimulus, the third plurality of nodes that include the vertex node 616, the overlay node 610, and the overlay node 620 are identified. As the overlay node 610 is already loaded into the executable graph-based model 100, only the vertex node 616 and the overlay node 620 are loaded into the executable graph-based model 100 based on the second stimulus. Further, the operation associated with the second stimulus is executed based on the vertex node 616, the overlay node 610, and the overlay node 620.

FIG. 6G is a schematic diagram 600G that illustrates resource utilization in the overlay system 202 using projections, in accordance with another embodiment of the present disclosure. Referring to FIG. 6G, the projection 602 may be loaded into the node layers 604, 606, and 608 in a manner similar to that described in FIG. 6A. Further, the stimuli management module 212 may be configured to receive a third stimulus of the set of stimuli 232 after the execution of the operation associated with the first stimulus. The third stimulus may correspond to a command or a query. Further, the stimuli management module 212, in conjunction with, the context module 210, the controller module 206, and the projection management module 224, may be configured to determine an additional node 630 associated with the processing of the third stimulus. The additional node 630 is structurally and functionally similar to the base node 302 which is described in conjunction with FIG. 3A. For the sake of ongoing discussion, the additional node 630 is assumed as an overlay node of the overlay node 612.

The additional node 630 is identified from the first plurality of nodes that are stored in the secondary storage element associated with storage management module 218. Further, the controller module 206, in conjunction with, the projection management module 224, may be configured to load the additional node 630 in the executable graph-based model 100, in association with the projection 602 such that the projection 602 includes the second plurality of nodes and the additional node 630. Further, the additional node 630 is loaded into an additional node layer 632 present in the executable graph-based model 100. The controller module 206, in conjunction with, the projection management module 224, executes an operation associated with the third stimulus based on the second plurality of nodes (i.e., the vertex node 302 and the overlay nodes 610 and 612) and the additional node 630, of the projection 602.

Although it is described that one additional node is required for the processing of the third stimulus, the scope of the present disclosure is not limited to it. In other embodiments, more than one additional node may be identified for the processing of the third stimulus and loaded into the executable graph-based model 100.

In an embodiment, each of the projections 602 and 615 may have a state and a manifest as described for an executable node in FIG. 5. In such a scenario, the projection 602 and/or the projection 615 may be loaded into the executable graph-based model 100 by utilizing the corresponding manifest as described in conjunction with FIG. 5

Although it is described that each node of the executable graph-based model 100 of FIGS. 6A-6G is a non-templated node (e.g., the node 302), the scope of the present disclosure is not limited to it. In other embodiments, each node of the executable graph-based model 100 of FIGS. 6A-6G may correspond to a templated node (e.g., the run-time node 336). In other words, each node of the executable graph-based model 100 of FIGS. 6A-6G may include a node template and one or more node instances. Similarly, each node layer of the executable graph-based model 100 of FIGS. 6A-6G may include a node template layer and one or more node instance layers. Such an implementation of the templatized version of the executable graph-based model 100 is shown in FIGS. 7A and 7B.

FIGS. 7A and 7B, are schematic diagrams 700A and 700B that collectively illustrate resource utilization in the overlay system 202 using projections, in accordance with yet another embodiment of the present disclosure. The first plurality of nodes stored in the secondary storage element associated with the storage management module 218 may include a first plurality of node templates and a first plurality of node instances. When the first stimulus is received, the second plurality of nodes are identified for the processing of the first stimulus. The second plurality of nodes include a second plurality of node templates and a second plurality of node instances identified from the first plurality of node templates and the first plurality of node instances, respectively. That is to say, the second plurality of node instances are identified based on the first context of the first stimulus. Further, the second plurality of node templates that are associated with the second plurality of node instances are identified. The second plurality of nodes are then loaded into the executable graph-based model 100. The loading of the second plurality of nodes into the executable graph-based model 100 corresponds to the loading of the second plurality of node templates and the second plurality of node instances into the executable graph-based model 100. Additionally, the first set of node layers of the executable graph-based model 100 includes a first set of node template layers and a first set of node instance layers such that the second plurality of node templates are loaded into the first set of node template layers and the second plurality of node instances are loaded into the first set of node instance layers.

Referring to FIG. 7A, the projection 602 includes the second plurality of nodes (e.g., the second plurality of node templates and the second plurality of node instances) loaded for the processing of the second stimulus. The second plurality of node templates that are loaded into the executable graph-based model 100 constitute a projection template 702 of the projection 602, and the second plurality of node instances that are loaded into the executable graph-based model 100 constitute a projection instance 704 of the projection 602. The first set of node template layers is shown to include a node template layer 706 and the first set of node instance layers is shown to include a node instance layer 708. Further, the vertex node 302 comprises a vertex node template 710 and a vertex node instance 712. Similarly, the overlay node 610 comprises an overlay node template 714 and an overlay node instance 716, whereas the overlay node 612 comprises an overlay node template 718 and an overlay node instance 720. The vertex node template 710, the overlay node template 714, and the overlay node template 718 constitute the second plurality of node templates, whereas the vertex node instance 712, the overlay node instance 716, and the overlay node instance 720, constitute the second plurality of node instances. As shown in FIG. 7A, the vertex node template 710, the overlay node template 714, and the overlay node template 718 are loaded into the node template layer 706, whereas the vertex node instance 712, the overlay node instance 716, and the overlay node instance 720 are loaded into the node instance layer 708.

Referring to FIG. 7B, in operation, the stimuli management module 212 may be further configured to receive a fourth stimulus of the set of stimuli 232 after the execution of the operation associated with the first stimulus. The fourth stimulus may correspond to a command or a query. Further, the stimuli management module 212, in conjunction with the context module 210, the controller module 206, and the projection management module 224, may be configured to identify a fourth plurality of node instances associated with the processing of the fourth stimulus. The fourth plurality of node instances are identified from the first plurality of node instances that are stored in the secondary storage element associated with the storage management module 218. The fourth plurality of node instances correspond to a plurality of implementations of the second plurality of node templates.

The fourth plurality of node instances include a vertex node instance 722, an overlay node instance 724, and an overlay node instance 726. Additionally, the overlay node instance 724 is an overlay of the vertex node instance 722, and the overlay node instance 726 is an overlay of the overlay node instance 724. The controller module 206, in conjunction with the projection management module 224, may be further configured to determine an association between each node instance of the fourth plurality node instances and a node instance layer of the first set of node instance layers based on a context of the fourth stimulus. Further, the controller module 206, in conjunction with the projection management module 224, may be configured to load the fourth plurality of node instances into the executable graph-based model 100. Particularly, the third plurality of the node instances are loaded into the node instance layer 708. Additionally, the fourth plurality of node instances are loaded simultaneously into the executable graph-based model 100. In an example, the context of the fourth stimulus may indicate the node instance layer ID of the node instance layer 708. Thus, the node instance layer ID of the node instance layer 708 may be utilized to load the fourth plurality of nodes into the node instance layer 708.

The fourth plurality of node instances, loaded into the executable graph-based model 100 constitute a projection instance 728. In other words, the vertex node instance 722, the overlay node instance 724, and the overlay node instance 726 constitute the projection instance 728. The projection management module 224, in conjunction with the controller module 206, may be further configured to execute an operation associated with the fourth stimulus based on the second plurality of the node templates and the fourth plurality of node instances. Thus, the fourth plurality of node instances that are required for the execution of the operation associated with the fourth stimulus are loaded simultaneously into the executable graph-based model 100 upon receiving the fourth stimulus. As a result, resource utilization of the primary storage element associated with the memory management module 216 is efficient. Additionally, as the fourth plurality of node instances are loaded simultaneously into the executable graph-based model 100, the latency involved with the execution of the operation associated with the fourth stimulus is minimized to near-zero latency.

Although it is described that the fourth plurality of node instances (i.e., the projection instance 728) are loaded into the node instance layer 708, the scope of the present disclosure is not limited to it. In other embodiments, the fourth plurality of node instances may be loaded into a different node instance layer.

In an embodiment, at least one of the projection instance 704 and the projection instance 728 may be unloaded from the executable graph-based model 100 upon the completion of the execution of the operation associated with the fourth stimulus. In other words, the projection management module 224, in conjunction with the controller module 206, unloads from the executable graph-based model 100, at least one node instance layer based on utilization of the corresponding node instance layer. In such an embodiment, the projection template 702 is retained in the executable graph-based model 100 as the projection template 702 may be required for the execution of operation associated with one or more different projection instances.

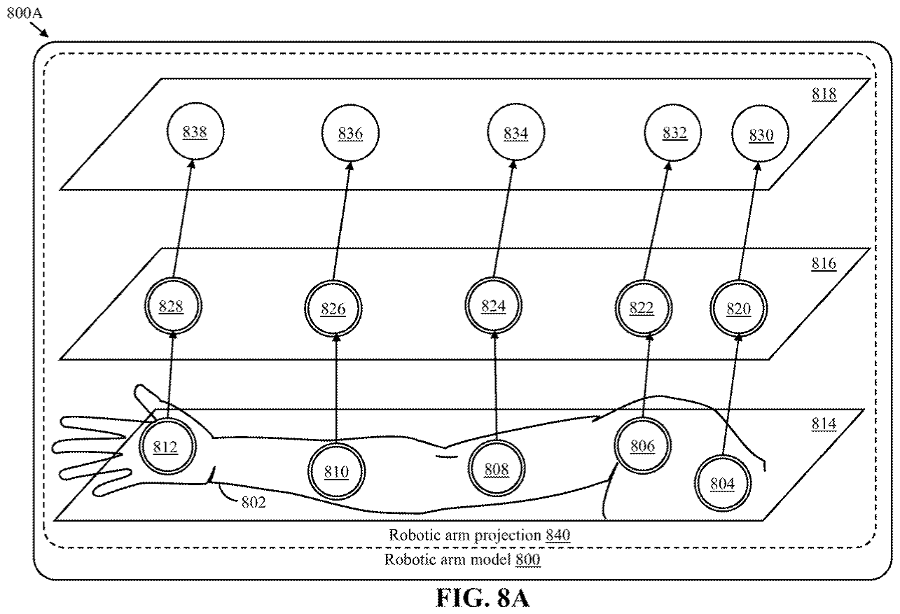

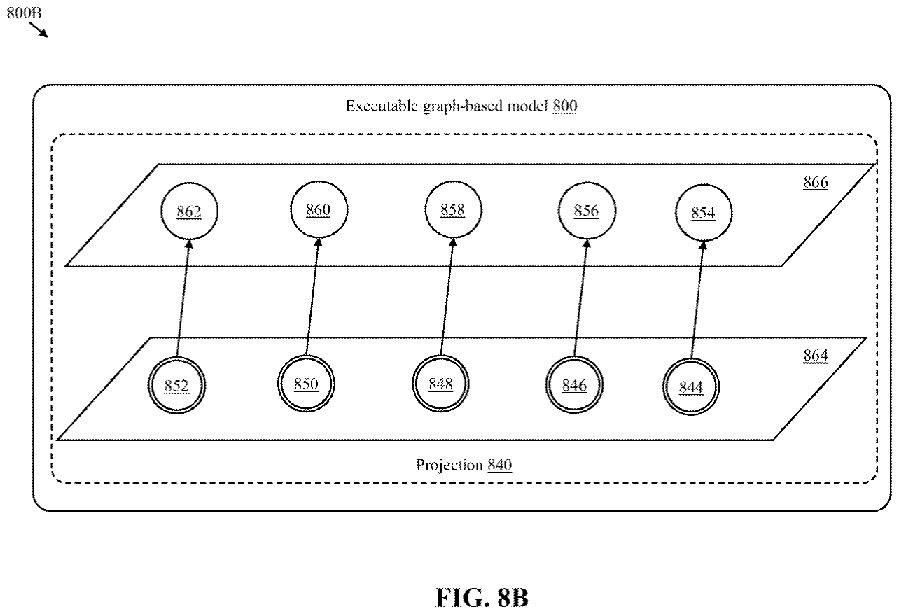

FIGS. 8A and 8B are schematic diagrams 800A and 800B that collectively illustrate an example implementation of resource utilization in the overlay system 202 using projections, in accordance with an embodiment of the present disclosure. Referring to FIG. 8A, an executable graph-based robotic arm model 800 is shown. The executable graph-based robotic arm model 800 corresponds to an executable graph-based model generated for a robotic arm 802, and can be alternatively referred to as the “robotic arm model 800”. The robotic arm model 800 is stored in the primary storage element associated with the memory management module 216. The robotic arm 802 includes various components such as a brain, a shoulder, an upper arm, a lower arm, and a hand. In such a scenario, nodes that represent the components of the robotic arm 802 are associated with the robotic arm model 800 and are stored in the storage management module 218. Such nodes are connected in a hierarchical structure. For example, the brain acts as a root, and the shoulder, the upper arm, the lower arm, and the hand act as intermediate nodes of the hierarchical structure of the robotic arm model 800. Root and intermediate nodes of the hierarchical structure have the edge node type. Hereinafter, each node with the edge node type is referred to as an edge.

The secondary storage element associated with the storage management module 218 stores a brain edge 804, a shoulder edge 806, an upper arm edge 808, a lower arm edge 810, and a hand edge 812, that represent the brain, the shoulder, the upper arm, the lower arm, and the hand, of the robotic arm 802, respectively. Various nodes of the robotic arm model 800 work in tandem to enable movement of the robotic arm 802. The vertices, edges, and role nodes of the robotic arm model 800, collectively, enable movement of the robotic arm 802. The robotic arm model 800 includes a third set of node layers that include node layers 814, 816, and 818.

The robotic arm 802 may be utilized for various applications such as in warehouses for performing pick and place operations, in operation theatres for performing complex surgeries, or the like. In operation, the stimuli management module 212 may receive a fifth stimulus of the set of stimuli 232. The fifth stimulus may correspond to a command. The fifth stimulus may indicate a movement of the robotic arm 802. Further, the stimuli management module 212, in conjunction with the context module 210, the controller module 206, and the projection management module 224, identifies a fifth plurality of nodes associated with the processing of the fifth stimulus. The fifth plurality of nodes are identified from the first plurality of nodes that are stored in the secondary storage element.

The fifth plurality of nodes are associated with the robotic arm 802 and include the brain edge 804, the shoulder edge 806, the upper arm edge 808, the lower arm edge 810, the hand edge 812, message handler overlay nodes 820-828, and message publisher overlay nodes 830-838. The message handler overlay nodes 820, 822, 824, 826, and 828 are overlays of the brain edge 804, the shoulder edge 806, the upper arm edge 808, the lower arm edge 810, and the hand edge 812, respectively. Further, the message publisher overlay nodes 830, 832, 834, 836, and 838 are overlays of the message handler overlay nodes 820, 822, 824, 826, and 828, respectively.

The controller module 206, in conjunction with the projection management module 224, may be further configured to determine an association between each node of the fifth plurality of nodes and a node layer of the third set of node layers based on a context of the fifth stimulus. Thus, the controller module 206, in conjunction with the projection management module 224, determines that the brain edge 804, the shoulder edge 806, the upper arm edge 808, the lower arm edge 810, and the hand edge 812 are associated with the node layer 814. The controller module 206, in conjunction with the projection management module 224, further determines that the message handler overlay nodes 820, 822, 824, 826, and 828 are associated with the node layer 816, and the message publisher overlay nodes 830, 832, 834, 836, and 838 are associated with the node layer 818.

The controller module 206, in conjunction with the projection management module 224, may be configured to load the fifth plurality of nodes, simultaneously, into the robotic arm model 800 based on the determined associations. Thus, the brain edge 804, the shoulder edge 806, the upper arm edge 808, the lower arm edge 810, and the hand edge 812 are loaded into the node layer 814, the message handler overlay nodes 820, 822, 824, 826, and 828 are loaded into the node layer 816, and the message publisher overlay nodes 830, 832, 834, 836, and 838 are loaded into the node layer 818. The brain edge 804, the shoulder edge 806, the upper arm edge 808, the lower arm edge 810, the hand edge 812, the message handler overlay nodes 820, 822, 824, 826, and 828, and the message publisher overlay nodes 830, 832, 834, 836, and 838 loaded into the robotic arm model 800 constitute a robotic arm projection 840. Further, the controller module 206, in conjunction with the projection management module 224, may be configured to execute an operation associated with the fifth stimulus based on the fifth plurality of nodes of the robotic arm projection 840.

The execution of the operation associated with the fifth stimulus includes, the message handler overlay nodes 820, 822, 824, 826, and 828 subscribing to a first set of messages associated with the message management module 222 and processing the first set of messages. The processing of the first set of messages results in the execution of the movement indicated by the fifth stimulus by the brain edge 804, the shoulder edge 806, the upper arm edge 808, the lower arm edge 810, and the hand edge 812. Upon the processing of the set of messages, the message publisher overlay nodes 830, 832, 834, 836, and 838 publish a second set of messages. The second set of messages includes first through fifth messages published by the message publisher overlay nodes 830, 832, 834, 836, and 838, respectively. Each message of the second set of messages may be indicative of data and transactional information that caused the movement of the robotic arm 802. Further, the controller module 206, in conjunction with the message management module 222 and the projection management module 224, may be configured to create a set of message nodes (not shown) in the robotic arm model 800 based on the second set of messages. Each message node of the set of message nodes includes a corresponding message of the second set of messages. The created set of message nodes is present in a message node layer of the third set of node layers. Thus, the robotic arm projection 840 further includes the set of message nodes.

The controller module 206, in conjunction with the projection management module 224, may be further configured to unload the projection 840 from the robotic arm model 800 based on one of (i) the execution of the operation associated with the fifth stimulus, (ii) lapse of a predetermined time duration, and (iii) exhaustion of resource of the primary storage element associated with the memory management module 216. That is to say, the brain edge 804, the shoulder edge 806, the upper arm edge 808, the lower arm edge 810, the hand edge 812, the message handler overlay nodes 820, 822, 824, 826, and 828, the message publisher overlay nodes 830, 832, 834, 836, and 838, and set of message nodes are unloaded from the robotic arm model 800 (e.g., primary storage element associated with the memory management module 216) to the secondary storage element associated with the storage management module 218.

Referring to FIG. 8B, the stimuli management module 212 may be further configured to receive a sixth stimulus of the set of stimuli 232 after the unloading of the robotic arm projection 840 from the robotic arm model 800. The sixth stimulus may correspond to a command that is indicative of an analytical operation associated with the robotic arm 802.

The stimuli management module 212, in conjunction with the context module 210, the controller module 206, and the projection management module 224, may be configured to identify the set of message nodes and a set of analytics overlay nodes associated with the processing of the sixth stimulus. The set of message nodes and the set of analytics overlay nodes are identified from the first plurality of nodes that are stored in the secondary storage element. The set of message nodes includes message nodes 844-852 and the set of analytics overlay nodes includes analytics overlay nodes 854-862. The message nodes 844-852 may be collectively indicative of the action performed by the robotic arm 802 that is described in conjunction with FIG. 8A. Further, the analytics overlay nodes 854, 856, 858, 860, and 862 are overlays of the message nodes 844, 846, 848, 850, and 852, respectively.

The controller module 206, in conjunction with the projection management module 224, may be further configured to determine an association between each node of the message nodes 844-852 and the analytics overlay nodes 854-862 and a node layer of the third set of node layers based on a sixth context of the sixth stimulus, where the third set of node layers further includes a node layer 864 (i.e., the message node layer) and a node layer 866 (i.e., the analytics node layer).

The controller module 206, in conjunction with the projection management module 224, may be configured to load the message nodes 844-852 and the analytics overlay nodes 854-862, simultaneously, into the robotic arm model 800 based on the determined associations. Thus, the message nodes 844, 846, 848, 850, and 852 are loaded into the node layer 864, and the analytics overlay nodes 854, 856, 858, 860, and 862 are loaded into the node layer 866. The message nodes 844-852 and the analytics overlay nodes 854-862 loaded into the robotic arm model 800 constitute the robotic arm projection 840. Further, the controller module 206, in conjunction with the projection management module 224, is configured to execute an operation associated with the sixth stimulus based on the message nodes 844-852 and the analytics overlay nodes 854-862 of the robotic arm projection 840.

The execution of the operation associated with the sixth stimulus includes the performance of an analytical operation based on the robotic arm 802 by the analytics overlay nodes 854, 856, 858, 860, and 862 based on the message nodes 844, 846, 848, 850, and 852. Further, an outcome is generated based on the analytical operation.

To summarize, only the nodes that are required for the execution of an operation associated with a corresponding stimulus are loaded into the robotic arm model 800. Additionally, the nodes are loaded simultaneously that is in a parallel manner. Also, upon exhaustion of the resource of the primary storage element associated with the memory management module 216 or upon the utilization of one or more nodes, corresponding nodes are unloaded from the robotic arm model 800 thus allocating space for new nodes. Hence, resource utilization in the overlay system 202 is improved with the use of projections. Also, as the nodes are loaded and unloaded simultaneously, the latency involved with the loading and unloading of the nodes is reduced.

Throughout the description, each node that is represented in a corresponding figure as an inner circle enclosed within an outer circle is an executable node. The inner circle represents its base node, and the outer circle represents an overlay node associated therewith. Further, the coupling of a first node with the inner circle represents an association between the executable node and the first node. A coupling between the outer circle and a second node indicates that the second node is an overlay of the executable node.

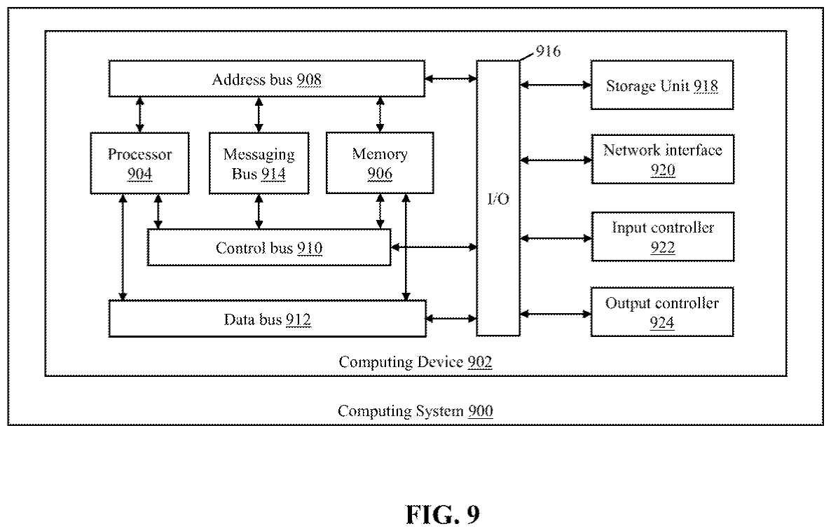

FIG. 9 shows an example computing system 900 for carrying out the methods of the present disclosure, in accordance with an embodiment of the present disclosure. Specifically, FIG. 9 shows a block diagram of an embodiment of the computing system 900 according to example embodiments of the present disclosure.

The computing system 900 may be configured to perform any of the operations disclosed herein, such as, for example, any of the operations discussed with reference to the functional modules described in relation to FIG. 2. The computing system 900 can be implemented as a conventional computer system, an embedded controller, a laptop, a server, a mobile device, a smartphone, a set-top box, a kiosk, a vehicular information system, one or more processors associated with a television, a customized machine, any other hardware platform, or any combination or multiplicity thereof. In one embodiment, the computing system 900 is a distributed system configured to function using multiple computing machines interconnected via a data network or bus system.

The computing system 900 includes computing devices (such as a computing device 902). The computing device 902 includes one or more processors (such as a processor 904) and a memory 906. The processor 904 may be any general-purpose processor(s) configured to execute a set of instructions. For example, the processor 904 may be a processor core, a multiprocessor, a reconfigurable processor, a microcontroller, a digital signal processor (DSP), an application-specific integrated circuit (ASIC), a graphics processing unit (GPU), a neural processing unit (NPU), an accelerated processing unit (APU), a brain processing unit (BPU), a data processing unit (DPU), a holographic processing unit (HPU), an intelligent processing unit (IPU), a microprocessor/microcontroller unit (MPU/MCU), a radio processing unit (RPU), a tensor processing unit (TPU), a vector processing unit (VPU), a wearable processing unit (WPU), a field programmable gate array (FPGA), a programmable logic device (PLD), a controller, a state machine, gated logic, discrete hardware component, any other processing unit, or any combination or multiplicity thereof. In one embodiment, the processor 904 may be multiple processing units, a single processing core, multiple processing cores, special purpose processing cores, co-processors, or any combination thereof. The processor 904 may be communicatively coupled to the memory 906 via an address bus 908, a control bus 910, a data bus 912, and a messaging bus 914.

The memory 906 may include non-volatile memories such as a read-only memory (ROM), a programable read-only memory (PROM), an erasable programmable read-only memory (EPROM), a flash memory, or any other device capable of storing program instructions or data with or without applied power. The memory 906 may also include volatile memories, such as a random-access-memory (RAM), a static random-access-memory (SRAM), a dynamic random-access-memory (DRAM), and a synchronous dynamic random-access-memory (SDRAM). The memory 906 may include single or multiple memory modules. While the memory 906 is depicted as part of the computing device 902, a person skilled in the art will recognize that the memory 906 can be separate from the computing device 902.

The memory 906 may store information that can be accessed by the processor 904. For instance, the memory 906 (e.g., one or more non-transitory computer-readable storage mediums, memory devices) may include computer-readable instructions (not shown) that can be executed by the processor 904. The computer-readable instructions may be software written in any suitable programming language or may be implemented in hardware. Additionally, or alternatively, the computer-readable instructions may be executed in logically and/or virtually separate threads on the processor 904. For example, the memory 906 may store instructions (not shown) that when executed by the processor 904 cause the processor 904 to perform operations such as any of the operations and functions for which the computing system 900 is configured, as described herein. Additionally, or alternatively, the memory 906 may store data (not shown) that can be obtained, received, accessed, written, manipulated, created, and/or stored. The data can include, for instance, the data and/or information described herein in relation to FIGS. 1-8. In some implementations, the computing device 902 may obtain from and/or store data in one or more memory device(s) that are remote from the computing system 900.

The computing device 902 may further include an input/output (I/O) interface 916 communicatively coupled to the address bus 908, the control bus 910, and the data bus 912. The data bus 912 and messaging bus 914 may include a plurality of tunnels that may support parallel execution of messages by the overlay system 202. The I/O interface 916 is configured to couple to one or more external devices (e.g., to receive and send data from/to one or more external devices). Such external devices, along with the various internal devices, may also be known as peripheral devices. The I/O interface 916 may include both electrical and physical connections for operably coupling the various peripheral devices to the computing device 902. The I/O interface 916 may be configured to communicate data, addresses, and control signals between the peripheral devices and the computing device 902. The I/O interface 916 may be configured to implement any standard interface, such as a small computer system interface (SCSI), a serial-attached SCSI (SAS), a fiber channel, a peripheral component interconnect (PCI), a PCI express (PCIe), a serial bus, a parallel bus, an advanced technology attachment (ATA), a serial ATA (SATA), a universal serial bus (USB), Thunderbolt, FireWire, various video buses, and the like. The I/O interface 916 is configured to implement only one interface or bus technology. Alternatively, the I/O interface 916 is configured to implement multiple interfaces or bus technologies. The I/O interface 916 may include one or more buffers for buffering transmissions between one or more external devices, internal devices, the computing device 902, or the processor 904. The I/O interface 916 may couple the computing device 902 to various input devices, including mice, touch screens, scanners, biometric readers, electronic digitizers, sensors, receivers, touchpads, trackballs, cameras, microphones, keyboards, any other pointing devices, or any combinations thereof. The I/O interface 916 may couple the computing device 902 to various output devices, including video displays, speakers, printers, projectors, tactile feedback devices, automation control, robotic components, actuators, motors, fans, solenoids, valves, pumps, transmitters, signal emitters, lights, and so forth.

The computing system 900 may further include a storage unit 918, a network interface 920, an input controller 922, and an output controller 924. The storage unit 918, the network interface 920, the input controller 922, and the output controller 924 are communicatively coupled to the central control unit (e.g., the memory 906, the address bus 908, the control bus 910, and the data bus 912) via the I/O interface 916. The network interface 920 communicatively couples the computing system 900 to one or more networks such as wide area networks (WAN), local area networks (LAN), intranets, the Internet, wireless access networks, wired networks, mobile networks, telephone networks, optical networks, or combinations thereof. The network interface 920 may facilitate communication with packet-switched networks or circuit-switched networks which use any topology and may use any communication protocol. Communication links within the network may involve various digital or analog communication media such as fiber optic cables, free-space optics, waveguides, electrical conductors, wireless links, antennas, radio-frequency communications, and so forth.

The storage unit 918 is a computer-readable medium, preferably a non-transitory computer-readable medium, comprising one or more programs, the one or more programs comprising instructions which when executed by the processor 904 cause the computing system 900 to perform the method steps of the present disclosure. Alternatively, the storage unit 918 is a transitory computer-readable medium. The storage unit 918 can include a hard disk, a floppy disk, a compact disc read-only memory (CD-ROM), a digital versatile disc (DVD), a Blu-ray disc, a magnetic tape, a flash memory, another non-volatile memory device, a solid-state drive (SSD), any magnetic storage device, any optical storage device, any electrical storage device, any semiconductor storage device, any physical-based storage device, any other data storage device, or any combination or multiplicity thereof. In one embodiment, the storage unit 918 stores one or more operating systems, application programs, program modules, data, or any other information. The storage unit 918 is part of the computing device 902. Alternatively, the storage unit 918 is part of one or more other computing machines that are in communication with the computing device 902, such as servers, database servers, cloud storage, network attached storage, and so forth.

The input controller 922 may include suitable logic, circuitry, interfaces, and/or code, executable by the circuitry, that may be configured to control one or more input devices that may be configured to receive an input (the set of stimuli 232) for the overlay system 202. The output controller 924 may include suitable logic, circuitry, interfaces, and/or code, executable by the circuitry, that may be configured to control one or more output devices that may be configured to render/output the outcome of the operation executed to process the received input (the set of stimuli 232).

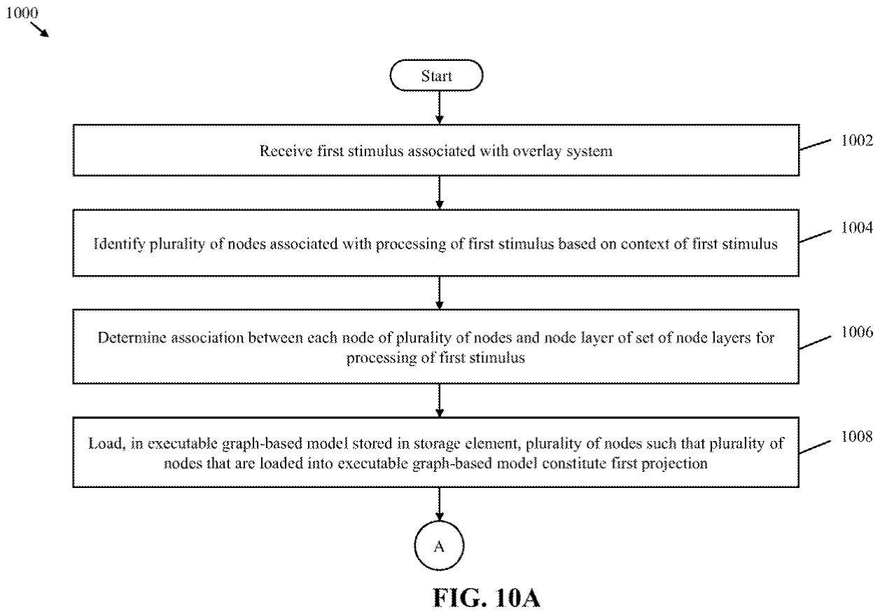

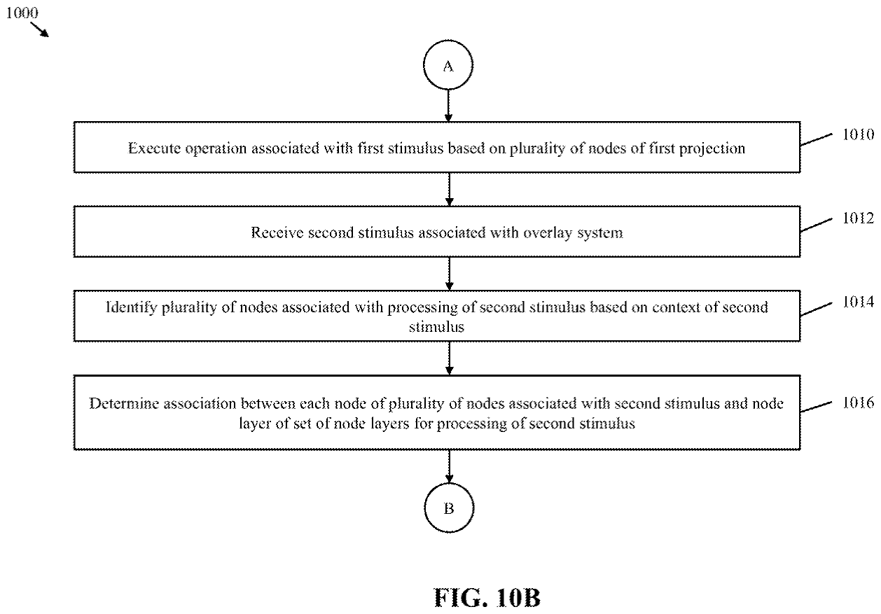

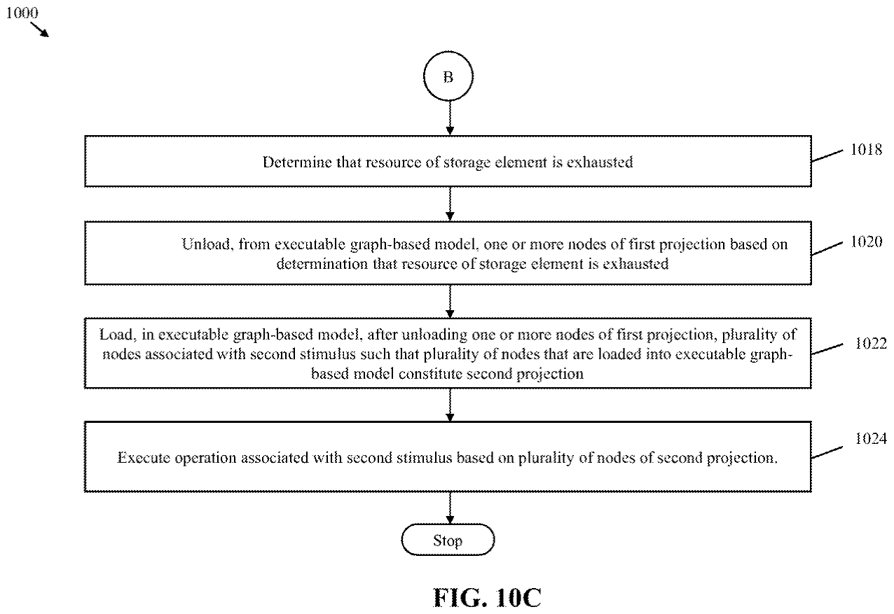

FIGS. 10A-10C, collectively, represents a flowchart 1000 that illustrates a method for facilitating resource utilization using projections in the overlay system 202, in accordance with an embodiment of the present disclosure. Referring to FIG. 10A, at 1002, the processing circuitry (e.g., the stimuli management module 212) of the overlay system 202 receives a first stimulus (e.g., the first stimulus of the set of stimuli 232) associated with the overlay system 202. At 1004, the processing circuitry (e.g., the stimuli management module 212, in conjunction with the controller module 206 and the projection management module 224) identifies a plurality of nodes (e.g., the second plurality of nodes) associated with the processing of the first stimulus based on a context of the first stimulus. At 1006, the processing circuitry (e.g., the stimuli management module 212 in conjunction with the controller module 206 and the projection management module 224) determines an association between each node of the plurality of nodes and a node layer of a set of node layers (e.g., the first set of node layers) for processing of the first stimulus.

At 1008, the processing circuitry (e.g., controller module 206 in conjunction with the projection management module 224) loads, in an executable graph-based model (e.g., the executable graph-based model 100) stored in the storage element (e.g., the primary storage element associated with the memory management module 216), the identified plurality of nodes such that the plurality of nodes that are loaded into the executable graph-based model constitute a first projection (e.g., the projection 602). The plurality of nodes are loaded simultaneously into the executable graph-based model.

Referring to FIG. 10B, at 1010, the processing circuitry (e.g., the projection management module 224, in conjunction with the controller module 206), executes an operation associated with the first stimulus based on the plurality of nodes of the first projection. At 1012, the processing circuitry (e.g., the stimuli management module 212) receives a second stimulus (e.g., the second stimulus of the set of stimuli 232) associated with the overlay system 202. At 1014, the processing circuitry (e.g., the stimuli management module 212 in conjunction with the controller module 206 and the projection management module 224) identifies another plurality of nodes (e.g., the third plurality of nodes) associated with the processing of the second stimulus based on a context of the second stimulus. At 1016, the processing circuitry (e.g., the stimuli management module 212 in conjunction with the controller module 206 and the projection management module 224) determines an association between each node of the plurality of nodes associated with the second stimulus and a node layer of a set of node layers (e.g., the second set of node layers) for processing of the second stimulus.

Referring to FIG. 10C, at 1018, the processing circuitry (e.g., the projection management module 224, in conjunction with the controller module 206), determines that the resource of a storage element (e.g., primary storage element associated with the memory management module 216) is exhausted. At 1020, the processing circuitry (e.g., the projection management module 224, in conjunction with the controller module 206), unloads one or more nodes of the first projection based on the determination that the resource of the storage element (e.g., the primary storage element associated with the memory management module 216) is exhausted, from the executable graph-based model (e.g., the executable graph-based model 100). The one or more nodes, from the executable graph-based model, (e.g., the executable graph-based model 100), are unloaded simultaneously.

At 1022, the processing circuitry (e.g., the projection management module 224, in conjunction with the controller module 206), loads, after unloading one or more nodes of the first projection, the plurality of nodes associated with the second stimulus into the executable graph-based model, such that the plurality of nodes that are loaded into executable graph-based model, constitute a second projection (e.g., the projection 615), and the plurality of nodes are loaded simultaneously into the executable graph-based model. At 1024, the processing circuitry (e.g., the projection management module 224, in conjunction with the controller module 206), executes an operation associated with the second stimulus based on the plurality of nodes of the second projection.

The disclosed embodiments encompass numerous advantages including an efficient and seamless approach for resource utilization in overlay systems using projections. As projection (such as the projections 602 or 614) that includes only the necessary nodes for processing the corresponding stimulus, is loaded into the primary storage element associated with the memory management module 216, the resource utilization of the primary storage element associated with the memory management module 216 is efficient. Further, one or more nodes or one or more node layers or an entire projection can be unloaded from the primary storage element associated with the memory management module 216 whenever the resource of the primary storage element associated with the memory management module 216 is exhausted, thereby facilitating efficient resource utilization. Additionally, multiple nodes of the projection are loaded simultaneously, from the storage management module 218 to the primary storage element associated with the memory management module 216. Thus, loading of the projection and stimulus processing exhibits significantly reduced latency. Additionally, the time complexity associated with stimulus processing is also reduced. The reduction in time complexity is beneficial in applications such as healthcare, finance, and robotics that involve time-critical operations based on resource utilization.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however, some of the operations may be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Certain embodiments of the disclosure may be found in the disclosed systems, methods, and non-transitory computer-readable medium, for facilitating resource utilization in overlay systems using projections. The methods and systems disclosed herein include various operations performed by the processing circuitry (e.g., the controller module 206, the context module 210, the stimuli management module 212, the projection management module 224, any other element of the overlay system 202, or a combination of two or more elements of the overlay system 202). The overlay system disclosed herein includes the storage element configured to store an executable graph-based model that comprises a first set of node layers. The overlay system further includes the processing circuitry that is coupled to the storage element. The processing circuitry is configured to receive a first stimulus associated with the overlay system. The processing circuitry is further configured to identify a first plurality of nodes associated with the processing of the first stimulus. Further, the processing circuitry determines an association between each node of the first plurality of nodes and a node layer of the first set of node layers based on a first context of the first stimulus. The processing circuitry further loads the first plurality of nodes into the executable graph-based model such that a set of nodes, of the first plurality of nodes, is loaded into at least the first node layer of the first set of node layers based on the association therebetween. The first plurality of nodes that are loaded into the executable graph-based model constitute a first projection. Also, the first plurality of nodes are loaded simultaneously. The processing circuitry further executes an operation associated with the first stimulus based on the first plurality of nodes of the first projection.

In some embodiments, the processing circuitry is further configured to determine that the resource of the storage element is exhausted during the processing of a second stimulus, where the second stimulus is processed after the first stimulus. The processing circuitry is further configured to unload one or more nodes of the first projection from the executable graph-based model based on the determination that the resource of the storage element is exhausted, where the one or more nodes are unloaded simultaneously.

In some embodiments, the processing circuitry is further configured to receive the second stimulus and identify a second plurality of nodes associated with the processing of the second stimulus. The processing circuitry is further configured to determine, based on a second context of the second stimulus, an association between each node of the second plurality of nodes and a node layer of one of a group consisting of (i) the first set of node layers and (ii) a second set of node layers of the executable graph-based model. The processing circuitry determines that the resource of the storage element is exhausted upon the determined association. Further, the processing circuitry loads, after the unloading of the one or more nodes of the first projection, the second plurality of nodes into the executable graph-based model based on the determined association. The second plurality of nodes that are loaded into the executable graph-based model constitute a second projection and the second plurality of nodes are loaded simultaneously. The processing circuitry further executes an operation associated with the second stimulus based on the second plurality of nodes of the second projection.

In some embodiments, the first plurality of nodes and the second plurality of nodes comprise at least a common set of nodes such that the first set of node layers and the second set of node layers comprise at least one common node layer that comprises the common set of nodes.

In some embodiments, the processing circuitry is further configured to determine, during the processing of a second stimulus, that the resource of the storage element is exhausted, where the second stimulus is processed after the first stimulus. Additionally, a third projection is loaded in the executable graph-based model prior to the second stimulus, where one or more nodes of the third projection are loaded into the first node layer. The processing circuitry is further configured to unload the first node layer from the executable graph-based model based on the determination that the resource of the storage element is exhausted. The unloading of the first node layer results in the unloading of the set of nodes of the first projection and the one or more nodes of the third projection. The set of nodes of the first projection and the one or more nodes of the third projection are unloaded simultaneously.

In some embodiments, the processing circuitry is further configured to unload, from the executable graph-based model, at least the first node layer of the first set of node layers based on utilization of the first node layer for the execution of the operation associated with the first stimulus based on the determination that the resource of the storage element is exhausted during processing of the second stimulus.

In some embodiments, a second node layer, of the first set of node layers, is dependent on the first node layer, and the processing circuitry is further configured to unload the second node layer along with the first node layer based on the dependency associated therewith.

In some embodiments, the processing circuitry is further configured to unload, from the executable graph-based model, the first projection based on the execution of the operation associated with the first stimulus, and the first plurality of nodes of the first projection are unloaded simultaneously.

In some embodiments, the processing circuitry is further configured to unload, from the executable graph-based model, at least a first node of the first plurality of nodes based on the lapse of a predetermined time duration after the execution of the operation associated with the first stimulus.

In some embodiments, each node layer of the first set of node layers has a unique node-layer-type, and the first plurality of nodes are loaded into the first set of node layers such that each node layer, of the first set of node layers, is loaded with a first set of nodes, of the first plurality of nodes, having a same node-type as the node-layer-type of the corresponding node layer.

In some embodiments, the first set of node layers comprises at least one of a group consisting of a vertex node layer, an edge node layer, at least a first type of overlay node layer, an index node layer, a history node layer, a message node layer, and a role node layer.

In some embodiments, the first type of overlay node layer corresponds to one of a group consisting of (i) a message handler overlay node layer, (ii) a message publisher overlay node layer, (iii) an encryption overlay node layer, (iv) an audit overlay node layer, (v) an obfuscation overlay node layer, (vi) a history overlay node layer, (vii) an analytics overlay node layer, (viii) a location overlay node layer, and (ix) a data quality overlay node layer.

In some embodiments, the first plurality of nodes comprise at least a first set of nodes, a second set of nodes, and a third set of nodes. Further, each node of the first set of nodes has a first node type, each node of the second set of nodes has a second node type, and each node of the third set of nodes has a third node type such that the first node type, the second node type, and the third node type are different. Further, the loading of the first plurality of nodes corresponds to the loading of the first set of nodes and the second set of nodes into one node layer of the first set of node layers, and the loading of the third set of nodes into a different node layer of the first set of node layers.

In some embodiments, the first plurality of nodes comprise one or more sets of nodes with each of the one or more sets of nodes having a different node type, and the loading of the first plurality of nodes corresponds to the loading of each of the one or more sets of nodes into one node layer of the first set of node layers.

In some embodiments, each node of the first plurality of nodes has a node type that corresponds to one of a group consisting of a vertex node type, an edge node type, at least a first overlay node type, an index node type, a history node type, a message node type, and a role node type.

In some embodiments, the first overlay node type corresponds to one of a group consisting of (i) a message handler overlay node type, (ii) a message publisher overlay node type, (iii) an encryption overlay node type, (iv) an audit overlay node type, (v) an obfuscation overlay node type, (vi) a history overlay node type, (vii) an analytics overlay node type, (viii) a location overlay node type, and (ix) a data quality overlay node type.

In some embodiments, the loading of the first plurality of nodes into the first set of node layers is a function of an association between one or more nodes of the first plurality of nodes.

In some embodiments, each node of the first plurality of nodes comprises a node template that corresponds to a predefined node structure and a node instance that corresponds to an implementation of the node template such that the first plurality of nodes comprises a first plurality of node templates and a first plurality of node instances. Further, the first set of node layers comprises a first set of node template layers and a first set of node instance layers such that the first node layer comprises a first node template layer and a first node instance layer. Additionally, a set of node templates, of the set of nodes, is loaded into the first node template layer, and a set of node instances, of the set of nodes, is loaded into the first node instance layer.

In some embodiments, the first plurality of node templates loaded into the executable graph-based model constitute a first projection template, and the first plurality of node instances loaded into the executable graph-based model constitute a first projection instance.

In some embodiments, the processing circuitry is further configured to receive a second stimulus associated with the overlay system. Further, the processing circuitry identifies a second plurality of node instances associated with the processing of the first stimulus. The second plurality of node instances correspond to a plurality of implementations of the first plurality of node templates. The processing circuitry is further configured to determine based on a second context of the second stimulus, an association between each node instance of the second plurality of node instances and a node instance layer of the first set of node instance layers. Additionally, the processing circuitry loads the second plurality of node instances into the executable graph-based model such that one or more node instances of the second plurality of node instances are loaded into at least the first node instance layer of the first set of node instance layers based on the association therebetween. Further, the second plurality of node instances that are loaded into the executable graph-based model constitute a second projection instance and the second plurality of node instances are loaded simultaneously. The processing circuitry further executes an operation associated with the second stimulus based on the second plurality of node instances and the first plurality of node templates.

In some embodiments, the processing circuitry is further configured to unload, from the executable graph-based model, at least one node instance layer based on the utilization of the corresponding node instance layer.

In some embodiments, the processing circuitry is further configured to create the first set of node layers in the executable graph-based model based on the reception of the first stimulus.

In some embodiments, the processing circuitry is further configured to receive a second stimulus and determine one or more additional nodes associated with the processing of the second stimulus. The processing circuitry further loads, in the executable graph-based model, the one or more additional nodes in association with the first projection such that the first projection comprises the first plurality of nodes and the one or more additional nodes. Further, the one or more additional nodes are loaded into an additional node layer, in addition to the first set of node layers present in the executable graph-based model. The processing circuitry executes an operation associated with the second stimulus based on the first plurality of nodes and the one or more additional nodes, of the first projection.

In some embodiments, a third plurality of nodes is associated with the overlay system, and the third plurality of nodes is arranged in the form of a plurality of node groups. Further, the processing circuitry is configured to identify, from the plurality of node groups, one or more node groups based on the first context of the first stimulus. The processing circuitry extracts, for the processing of the first stimulus, one or more nodes from each identified node group, such that the one or more nodes extracted from each identified node group constitute the first plurality of nodes.

In some embodiments, the first stimulus corresponds to one of a group consisting of a command and a query.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however, some of the operations may be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the present disclosure provide, among other features, systems and methods for resource utilization in overlay systems using projections. While various embodiments of the disclosed systems and methods have been described above, it should be understood that they have been presented for purposes of example only, and not limitations. It is not exhaustive and does not limit the present disclosure to the precise form disclosed. Modifications and variations are possible in light of the above teachings or may be acquired from practicing the present disclosure, without departing from the breadth or scope.

Moreover, for example, the present technology/system may achieve the following configurations:

1. An overlay system, comprising:
a storage element configured to store an executable graph-based model that comprises a first set of node layers; and
processing circuitry that is coupled to the storage element, and configured to:
receive a first stimulus associated with the overlay system;
identify a first plurality of nodes associated with processing of the first stimulus;
determine, based on a first context of the first stimulus, an association between each node of the first plurality of nodes and a node layer of the first set of node layers;
load the first plurality of nodes into the executable graph-based model such that a set of nodes, of the first plurality of nodes, is loaded into at least a first node layer of the first set of node layers based on the association therebetween, wherein the first plurality of nodes are loaded simultaneously, and wherein the first plurality of nodes that are loaded into the executable graph-based model constitute a first projection; and
execute an operation associated with the first stimulus based on the first plurality of nodes of the first projection.

2. The overlay system of 1, wherein the processing circuitry is further configured to:
determine, during processing of a second stimulus, that resource of the storage element is exhausted, wherein the second stimulus is processed after the first stimulus; and
unload one or more nodes of the first projection from the executable graph-based model based on the determination that the resource of the storage element is exhausted, wherein the one or more nodes are unloaded simultaneously.

3. The overlay system of 2, wherein the processing circuitry is further configured to:
receive the second stimulus;
identify a second plurality of nodes associated with processing of the second stimulus;
determine, based on a second context of the second stimulus, an association between each node of the second plurality of nodes and a node layer of one of a group consisting of (i) the first set of node layers and (ii) a second set of node layers of the executable graph-based model, wherein the processing circuitry determines that the resource of the storage element is exhausted upon the determined association;
load, after the unloading of the one or more nodes of the first projection, the second plurality of nodes into the executable graph-based model based on the determined association, wherein the second plurality of nodes are loaded simultaneously, and wherein the second plurality of nodes that are loaded into the executable graph-based model constitute a second projection; and
execute an operation associated with the second stimulus based on the second plurality of nodes of the second projection.

4. The overlay system of 3, wherein the first plurality of nodes and the second plurality of nodes comprise at least a common set of nodes, and wherein the first set of node layers and the second set of node layers comprise at least one common node layer that comprises the common set of nodes.

5. The overlay system of 2, wherein the processing circuitry is further configured to:
determine, during processing of a second stimulus, that resource of the storage element is exhausted, wherein the second stimulus is processed after the first stimulus, and wherein a third projection is loaded in the executable graph-based model prior to the second stimulus, where one or more nodes of the third projection are loaded into the first node layer; and
unload the first node layer from the executable graph-based model based on the determination that the resource of the storage element is exhausted, wherein the unloading of the first node layer results in unloading of the set of nodes of the first projection and the one or more nodes of the third projection, and wherein the set of nodes of the first projection and the one or more nodes of the third projection are unloaded simultaneously

6. The overlay system of 1, wherein the processing circuitry is further configured to unload, from the executable graph-based model, at least the first node layer of the first set of node layers based on utilization of the first node layer for the execution of the operation associated with the first stimulus.

7. The overlay system of 6, wherein a second node layer, of the first set of node layers, is dependent on the first node layer, and wherein the processing circuitry is further configured to unload the second node layer along with the first node layer based on the dependency associated therewith.

8. The overlay system of 1, wherein the processing circuitry is further configured to unload, from the executable graph-based model, the first projection based on the execution of the operation associated with the first stimulus, and wherein the first plurality of nodes of the first projection are unloaded simultaneously.

9. The overlay system of 1, wherein the processing circuitry is further configured to unload, from the executable graph-based model, at least a first node of the first plurality of nodes based on lapse of a predetermined time duration after the execution of the operation associated with the first stimulus.

10. The overlay system of 1, wherein each node layer of the first set of node layers has a unique node-layer-type, and wherein the first plurality of nodes are loaded into the first set of node layers such that each node layer, of the first set of node layers, is loaded with the set of nodes, of the first plurality of nodes, having a same node-type as the node-layer-type of the corresponding node layer.

11. The overlay system of 10, wherein the first set of node layers comprises at least one of a group consisting of a vertex node layer, an edge node layer, at least a first type of overlay node layer, an index node layer, a history node layer, a message node layer, and a role node layer.

12. The overlay system of 11, wherein the first type of overlay node layer corresponds to one of a group consisting of (i) a message handler overlay node layer, (ii) a message publisher overlay node layer, (iii) an encryption overlay node layer, (iv) an audit overlay node layer, (v) an obfuscation overlay node layer, (vi) a history overlay node layer, (vii) an analytics overlay node layer, (viii) a location overlay node layer, and (ix) a data quality overlay node layer.

13. The overlay system of 1,
wherein the first plurality of nodes comprise at least a first set of nodes, a second set of nodes, and a third set of nodes,
wherein each node of the first set of nodes has a first node type, each node of the second set of nodes has a second node type, and each node of the third set of nodes has a third node type,
wherein the first node type, the second node type, and the third node type are different, and
wherein the loading of the first plurality of nodes corresponds to loading of the first set of nodes and the second set of nodes into one node layer of the first set of node layers, and loading of the third set of nodes into a different node layer of the first set of node layers.

14. The overlay system of 1,
wherein the first plurality of nodes comprise one or more sets of nodes with each of the one or more sets of nodes having a different node type, and
wherein the loading of the first plurality of nodes corresponds to loading of each of the one or more sets of nodes into one node layer of the first set of node layers.

15. The overlay system of 1, wherein each node of the first plurality of nodes has a node type that corresponds to one of a group consisting of a vertex node type, an edge node type, at least a first overlay node type, an index node type, a history node type, a message node type, and a role node type.

16. The overlay system of 15, wherein the first overlay node type corresponds to one of a group consisting of (i) a message handler overlay node type, (ii) a message publisher overlay node type, (iii) an encryption overlay node type, (iv) an audit overlay node type, (v) an obfuscation overlay node type, (vi) a history overlay node type, (vii) an analytics overlay node type, (viii) a location overlay node type, and (ix) a data quality overlay node type.

17. The overlay system of 1, wherein the loading of the first plurality of nodes into the first set of node layers is a function of an association between one or more nodes of the first plurality of nodes.

18. The overlay system of 1,
wherein each node of the first plurality of nodes comprises a node template that corresponds to a predefined node structure and a node instance that corresponds to an implementation of the node template such that the first plurality of nodes comprises a first plurality of node templates and a first plurality of node instances,
wherein the first set of node layers comprises a first set of node template layers and a first set of node instance layers such that the first node layer comprises a first node template layer and a first node instance layer, and
wherein a set of node templates, of the set of nodes, is loaded into the first node template layer and a set of node instances, of the set of nodes, is loaded into the first node instance layer.

19. The overlay system of 18, wherein the first plurality of node templates loaded into the executable graph-based model constitute a first projection template, and the first plurality of node instances loaded into the executable graph-based model constitute a first projection instance.

20. The overlay system of 19, wherein the processing circuitry is further configured to
receive a second stimulus associated with the overlay system;
identify a second plurality of node instances associated with processing of the first stimulus, wherein the second plurality of node instances correspond to a plurality of implementations of the first plurality of node templates;
determine, based on a second context of the second stimulus, an association between each node instance of the second plurality of node instances and a node instance layer of the first set of node instance layers;
load the second plurality of node instances into the executable graph-based model such that one or more node instances of the second plurality of node instances are loaded into at least the first node instance layer of the first set of node instance layers based on the association therebetween, wherein the second plurality of node instances are loaded simultaneously, and wherein the second plurality of node instances that are loaded into the executable graph-based model constitute a second projection instance; and
execute an operation associated with the second stimulus based on the second plurality of node instances and the first plurality of node templates.

21. The overlay system of 18, wherein the processing circuitry is further configured to unload, from the executable graph-based model, at least one node instance layer based on utilization of the corresponding node instance layer.

22. The overlay system of 1, wherein the processing circuitry is further configured to create the first set of node layers in the executable graph-based model based on the reception of the first stimulus.

23. The overlay system of 1, wherein the processing circuitry is further configured to:
receive a second stimulus;
determine one or more additional nodes associated with the processing of the second stimulus;
load, in the executable graph-based model, the one or more additional nodes in association with the first projection such that the first projection comprises the first plurality of nodes and the one or more additional nodes, wherein the one or more additional nodes are loaded into an additional node layer, in addition to the first set of node layers, present in the executable graph-based model; and
execute an operation associated with the second stimulus based on the first plurality of nodes and the one or more additional nodes, of the first projection.

24. The overlay system of 1,
wherein a third plurality of nodes is associated with the overlay system,
wherein the third plurality of nodes is arranged in form of a plurality of node groups, and
wherein the processing circuitry is further configured to (i) identify, from the plurality of node groups, one or more node groups based on the first context of the first stimulus, and (ii) extract, for the processing of the first stimulus, one or more nodes from each identified node group, such that the one or more nodes extracted from each identified node group constitute the first plurality of nodes.

25. The overlay system of 1, wherein the first stimulus corresponds to one of a group consisting of a command and a query.

26. A method, comprising:
receiving, by processing circuitry of an overlay system, a first stimulus associated with the overlay system;
identifying, by the processing circuitry, a first plurality of nodes associated with processing of the first stimulus;
determining, by the processing circuitry, based on a first context of the first stimulus, an association between each node of the first plurality of nodes with a node layer of a first set of node layers, wherein an executable graph-based model, stored in a storage element of the overlay system, comprises the first set of node layers;
loading, by the processing circuitry, the first plurality of nodes into the executable graph-based model such that one or more nodes of the first plurality of nodes are loaded into at least a first node layer of the first set of node layers based on the association therebetween, wherein the first plurality of nodes that are loaded into the executable graph-based model constitute a first projection, and wherein the first plurality of nodes are loaded simultaneously; and
executing, by the processing circuitry, an operation associated with the first stimulus based on the first plurality of nodes of the first projection.

What is claimed is:

1. An overlay system, comprising:
a storage element configured to store an executable graph-based model that comprises a first set of node layers; and
processing circuitry that is coupled to the storage element, and configured to:
receive a first stimulus associated with the overlay system;
identify a first plurality of nodes associated with processing of the first stimulus;
determine, based on a first context of the first stimulus, an association between each node of the first plurality of nodes and a node layer of the first set of node layers;
load the first plurality of nodes into the executable graph-based model such that a set of nodes, of the first plurality of nodes, is loaded into at least a first node layer of the first set of node layers based on the association therebetween, wherein the first plurality of nodes are loaded simultaneously, and wherein the first plurality of nodes that are loaded into the executable graph-based model constitute a first projection; and
execute an operation associated with the first stimulus based on the first plurality of nodes of the first projection.

2. The overlay system of claim 1, wherein the processing circuitry is further configured to:
determine, during processing of a second stimulus, that resource of the storage element is exhausted, wherein the second stimulus is processed after the first stimulus; and
unload one or more nodes of the first projection from the executable graph-based model based on the determination that the resource of the storage element is exhausted, wherein the one or more nodes are unloaded simultaneously.

3. The overlay system of claim 2, wherein the processing circuitry is further configured to:
receive the second stimulus;
identify a second plurality of nodes associated with processing of the second stimulus;
determine, based on a second context of the second stimulus, an association between each node of the second plurality of nodes and a node layer of one of a group consisting of (i) the first set of node layers and (ii) a second set of node layers of the executable graph-based model, wherein the processing circuitry determines that the resource of the storage element is exhausted upon the determined association;
load, after the unloading of the one or more nodes of the first projection, the second plurality of nodes into the executable graph-based model based on the determined association, wherein the second plurality of nodes are loaded simultaneously, and wherein the second plurality of nodes that are loaded into the executable graph-based model constitute a second projection; and
execute an operation associated with the second stimulus based on the second plurality of nodes of the second projection.

4. The overlay system of claim 3, wherein the first plurality of nodes and the second plurality of nodes comprise at least a common set of nodes, and wherein the first set of node layers and the second set of node layers comprise at least one common node layer that comprises the common set of nodes.

5. The overlay system of claim 1, wherein the processing circuitry is further configured to:
determine, during processing of a second stimulus, that resource of the storage element is exhausted, wherein the second stimulus is processed after the first stimulus, and wherein a third projection is loaded in the executable graph-based model prior to the second stimulus, where one or more nodes of the third projection are loaded into the first node layer; and
unload the first node layer from the executable graph-based model based on the determination that the resource of the storage element is exhausted, wherein the unloading of the first node layer results in unloading of the set of nodes of the first projection and the one or more nodes of the third projection, and wherein the set of nodes of the first projection and the one or more nodes of the third projection are unloaded simultaneously.

6. The overlay system of claim 1, wherein the processing circuitry is further configured to unload, from the executable graph-based model, at least the first node layer of the first set of node layers based on utilization of the first node layer for the execution of the operation associated with the first stimulus.

7. The overlay system of claim 6, wherein a second node layer, of the first set of node layers, is dependent on the first node layer, and wherein the processing circuitry is further configured to unload the second node layer along with the first node layer based on the dependency associated therewith.

8. The overlay system of claim 1, wherein the processing circuitry is further configured to unload, from the executable graph-based model, the first projection based on the execution of the operation associated with the first stimulus, and wherein the first plurality of nodes of the first projection are unloaded simultaneously.

9. The overlay system of claim 1, wherein the processing circuitry is further configured to unload, from the executable graph-based model, at least a first node of the first plurality of nodes based on lapse of a predetermined time duration after the execution of the operation associated with the first stimulus.

10. The overlay system of claim 1, wherein each node layer of the first set of node layers has a unique node-layer-type, and wherein the first plurality of nodes are loaded into the first set of node layers such that each node layer, of the first set of node layers, is loaded with the set of nodes, of the first plurality of nodes, having a same node-type as a node-layer-type of the corresponding node layer.

11. The overlay system of claim 10, wherein the first set of node layers comprises at least one of a group consisting of a vertex node layer, an edge node layer, at least a first type of overlay node layer, an index node layer, a history node layer, a message node layer, and a role node layer.

12. The overlay system of claim 1,
wherein the first plurality of nodes comprise at least a first set of nodes, a second set of nodes, and a third set of nodes,
wherein each node of the first set of nodes has a first node type, each node of the second set of nodes has a second node type, and each node of the third set of nodes has a third node type,
wherein the first node type, the second node type, and the third node type are different, and
wherein the loading of the first plurality of nodes corresponds to loading of the first set of nodes and the second set of nodes into one node layer of the first set of node layers, and loading of the third set of nodes into a different node layer of the first set of node layers.

13. The overlay system of claim 1,
wherein the first plurality of nodes comprise one or more sets of nodes with each of the one or more sets of nodes having a different node type, and
wherein the loading of the first plurality of nodes corresponds to loading of each of the one or more sets of nodes into one node layer of the first set of node layers.

14. The overlay system of claim 1, wherein each node of the first plurality of nodes has a node type that corresponds to one of a group consisting of a vertex node type, an edge node type, at least a first overlay node type, an index node type, a history node type, a message node type, and a role node type.

15. The overlay system of claim 1,
wherein each node of the first plurality of nodes comprises a node template that corresponds to a predefined node structure, and a node instance that corresponds to an implementation of the node template such that the first plurality of nodes comprise a first plurality of node templates and a first plurality of node instances,
wherein the first set of node layers comprises a first set of node template layers and a first set of node instance layers such that the first node layer comprises a first node template layer and a first node instance layer,
wherein a set of node templates, of the set of nodes, is loaded into the first node template layer, and a set of node instances, of the set of nodes, is loaded into the first node instance layer, and
wherein the first plurality of node templates loaded into the executable graph-based model constitute a first projection template, and the first plurality of node instances loaded into the executable graph-based model constitute a first projection instance.

16. The overlay system of claim 15, wherein the processing circuitry is further configured to
receive a second stimulus associated with the overlay system;
identify a second plurality of node instances associated with processing of the first stimulus, wherein the second plurality of node instances correspond to a plurality of implementations of the first plurality of node templates;
determine, based on a second context of the second stimulus, an association between each node instance of the second plurality of node instances and a node instance layer of the first set of node instance layers;
load the second plurality of node instances into the executable graph-based model such that one or more node instances of the second plurality of node instances are loaded into at least the first node instance layer of the first set of node instance layers based on the association therebetween, wherein the second plurality of node instances are loaded simultaneously, and wherein the second plurality of node instances that are loaded into the executable graph-based model constitute a second projection instance; and
execute an operation associated with the second stimulus based on the second plurality of node instances and the first plurality of node templates.

17. The overlay system of claim 15, wherein the processing circuitry is further configured to unload, from the executable graph-based model, at least one node instance layer based on utilization of the corresponding node instance layer.

18. The overlay system of claim 1, wherein the processing circuitry is further configured to:
receive a second stimulus;
determine one or more additional nodes associated with the processing of the second stimulus;
load, in the executable graph-based model, the one or more additional nodes in association with the first projection such that the first projection comprises the first plurality of nodes and the one or more additional nodes, wherein the one or more additional nodes are loaded into an additional node layer, in addition to the first set of node layers, present in the executable graph-based model; and
execute an operation associated with the second stimulus based on the first plurality of nodes and the one or more additional nodes, of the first projection.

19. The overlay system of claim 1,
wherein a third plurality of nodes is associated with the overlay system,
wherein the third plurality of nodes is arranged in form of a plurality of node groups, and
wherein the processing circuitry is further configured to (i) identify, from the plurality of node groups, one or more node groups based on the first context of the first stimulus, and (ii) extract, for the processing of the first stimulus, one or more nodes from each identified node group, such that the one or more nodes extracted from each identified node group constitute the first plurality of nodes.

20. A method, comprising:
receiving, by processing circuitry of an overlay system, a first stimulus associated with the overlay system;
identifying, by the processing circuitry, a first plurality of nodes associated with processing of the first stimulus;
determining, by the processing circuitry, based on a first context of the first stimulus, an association between each node of the first plurality of nodes with a node layer of a first set of node layers, wherein an executable graph-based model, stored in a storage element of the overlay system, comprises the first set of node layers;
loading, by the processing circuitry, the first plurality of nodes into the executable graph-based model such that a first set of nodes, of the first plurality of nodes, is loaded into at least a first node layer of the first set of node layers based on the association therebetween, wherein the first plurality of nodes are loaded simultaneously, and wherein the first plurality of nodes that are loaded into the executable graph-based model constitute a first projection; and
executing, by the processing circuitry, an operation associated with the first stimulus based on the first plurality of nodes of the first projection.
